(19) United States
(12) Patent Application Publication
(10) Pub. No.: US 2013/0155039 A1
(43) Pub. Date: Jun. 20, 2013

(54) IMAGE GENERATING APPARATUS, IMAGE DISPLAY APPARATUS, IMAGE GENERATING METHOD, AND IMAGE DISPLAY METHOD

(71) Applicant: CANON KABUSHIKI KAISHA, Tokyo (JP)

(72) Inventors: Yuka Fujinaka, Ebina-shi (JP); Tetsu Fukuda, Hiratsuka-shi (JP); Satoshi Ukawa, Komae-shi (JP)

(73) Assignee: CANON KABUSHIKI KAISHA, Tokyo (JP)

(21) Appl. No.: 13/710,949

(22) Filed: Dec. 11, 2012

(30) Foreign Application Priority Data
Dec. 19, 2011 (JP) 2011-277396
Sep. 13, 2012 (JP) 2012-201920

(51) Int. Cl. G09G 5/00

(52) U.S. Cl. CPC G09G 5/00
USPC 345/204; 345/619

(57) ABSTRACT

An image generating apparatus according to the present invention is an image generating apparatus that generates pattern image data including a pattern component image for inspecting display quality of an image display apparatus in which an emission brightness of a backlight can be controlled for each block obtained by dividing a screen. The image generating apparatus according to the present invention comprises a detecting unit that detects a block in which display quality is estimated to be degraded, from among the blocks of the image display apparatus, as a degradation estimation region; and a generating unit that generates pattern image data such that the pattern component image is displayed in a block detected as the degradation estimation region by the detecting units when an image based on the pattern image data is displayed by the image display apparatus.

### BACKGROUND OF THE INVENTION

1. Field of the Invention

The present invention relates to an image generating apparatus, an image display apparatus, an image generating method, and an image display method.

2. Description of the Related Art

In the medical field, visual inspection or measurement inspection is carried out on a daily basis according to the guidelines (Japanese Engineering Standards of Radiological Apparatus (JESRA X-0093)) stipulated by Japan Medical Imaging and Radiological Systems Industries Association (JIRA) with the object of quality (display quality) management of medical imaging monitors (referred to hereinbelow as “monitors”). For example, pattern image (JIRA TG18-QC) shown in FIG. 22 are displayed on a monitor and visual inspection is performed. The inspector visually checks the display state of pattern component images 80, 81, 82, 83, 84 in the displayed pattern image and performs quality evaluation of the monitor.

As the usage time of a monitor increases, the display quality is degraded, for example, tinge variations occur, due to the decrease in emission brightness of a backlight or degradation of optical materials. The conventional liquid crystal monitors include a backlight using a cold-cathode fluorescent lamp (CCFL) as a light source, and it is presumed that the CCFL is uniformly lit up over the entire backlight surface. Accordingly, the degradation of display quality occurs over the entire monitor screen.

Japanese Patent Application Publication No. 2009-93098 describes a technique for detecting the degradation of a fluorescent lamp serving as a light source of a backlight and warning the user about the degradation. More specifically, Japanese Patent Application Publication No. 2009-93098 discloses a method including the steps of calculating a difference between a brightness value at the time the backlight is assembled (initial brightness value) and a measured present brightness value and notifying a message indicating the degradation degree to the user when the difference reaches a predetermined reference value.

A local dimming function (referred to hereinbelow as LD function) of adjusting the emission brightness of a backlight for each block obtained by dividing a screen area became widely used in recent years. With the LD function, the black level of the dark regions of the image is reduced and image contrast is increased by dimming the backlight in some regions.

In medical diagnostics, medical images are used that are picked up by diagnostic apparatuses such as X-ray imaging apparatuses, CT (Computed Tomography) apparatuses, and MRI (Magnetic Resonance Imaging) diagnostic apparatuses. In such medical images, the background regions are represented by black color and the diagnostic regions (examination object) are represented by white color. By using the LD function, it is possible to improve the gradation of the diagnostic regions. Therefore, the LD function is effective for efficient and accurate medical diagnostics.

However, when the LD function is continuously used, only the backlight in a partial region of the screen is sometimes continuously lit up at a high-brightness value. As a result, the backlight is locally degraded and eventually the display quality is locally degraded.

The local degradation of a backlight occurring when the LD function is used is explained below with reference to FIG. 23. The reference numeral 90 in the figure stands for a backlight light source. Where the backlight is continuously used for a long time in a state in which the emission brightness of the light sources within the bold-line frames 92a, 92b is higher than the emission brightness of other light sources, the degradation of the light sources within the bold-line frames 92a, 92b is larger than that of other light sources. The region where such degradation occurs strongly depends on the image display position (region). However, in the medical field, the image display position differs depending on the preferences of a radiologist and therefore the backlight does not necessarily degrade in a specific region.

FIGS. 24A to 24C illustrate a display example of a diagnostic image during mammography diagnostics. FIG. 24A shows as example in which the diagnostic images are displayed (arranged) on the left and right ends of the screen. FIG. 24B shows as example in which the diagnostic image is displayed in the center of the screen. FIG. 24C shows as example in which the diagnostic images are displayed in the center and on the right end of the screen. Thus, the arrangement of diagnostic images differs depending on the preferences of each radiologist. Therefore, the region (degradation region) in which the backlight (and eventually the display quality) is greatly degraded when the LD function is used changes depending on the image display method and is not fixed.

### SUMMARY OF THE INVENTION

However, in the above-described conventional technique such local degradation of display quality of the monitor has not been taken into account. Therefore, the user could not determine the local degradation state of the monitor.

Further, the display position of pattern component images in the pattern image determined by the guidelines is fixed. Therefore, in some cases, the inspection is performed in a state in which the pattern component images of interest are not displayed in the degradation region.

The difference in viewing the pattern component images displayed in the degradation region and non-degradation region (region outside the degradation region) is explained below with reference to FIGS. 26A and 26B.

FIG. 26A shows an example in which a pattern component image is displayed in a non-degradation region. FIG. 26A demonstrates that where a pattern component image is displayed in the non-degradation region, the pattern component image is displayed in a monotonous continuous fashion with smooth gradation.

FIG. 26B shows an example in which a pattern component image is displayed in a degradation region. FIG. 26B demonstrates that part (upper part) of the pattern component image is not displayed in a monotonous continuous fashion.

In some cases, when the conventional technique is used, the pattern image (FIG. 25) where the pattern component image is arranged in a region (non-degradation region) other than the degradation regions 92a, 92b shown in FIG. 23 is visually examined. Therefore, the user recognizes the pattern component image (FIG. 26A) displayed in the non-degradation region during visual examination and determines that no degradation has occurred. It is thus possible that the user could continue using the monitor (image display apparatus) with degraded quality for diagnostics, without noticing the degradation of display quality, and could make a wrong diagnosis.

The present invention provides a technique that enables accurate inspection of the degradation state of an image display apparatus.

The present invention in its first aspect provides an image generating apparatus that generates pattern image data including a pattern component image for inspecting display quality of an image display apparatus in which an emission brightness of a backlight can be controlled for each block obtained by dividing a screen,

the image generating apparatus comprising:

a detecting unit that detects a block in which display quality is estimated to be degraded, from among the blocks of the image display apparatus, as a degradation estimation region; and

a generating unit that generates pattern image data such that the pattern component image is displayed in a block detected as the degradation estimation region by the detecting units when an image based on the pattern image data is displayed by the image display apparatus.

The present invention in its second aspect provides

an image display apparatus in which an emission brightness of a backlight can be controlled for each block obtained by dividing a screen,

the image display apparatus comprising:

a detecting unit that detects a block in which display quality is estimated to be degraded, from among the blocks, as a degradation estimation region; and

a display control unit that displays a pattern component image for inspecting display quality in block detected as the degradation estimation region by the detecting unit.

The present invention in its third aspect provides

an image generating method for generating pattern image data including a pattern component image for inspecting display quality of an image display apparatus in which an emission brightness of a backlight can be controlled for each block obtained by dividing a screen,

the image generating method comprising:

a detection step in which a computer detects a block in which display quality is estimated to be degraded, from among the blocks of the image display apparatus, as a degradation estimation region; and

a generation step in which the computer generates pattern image data such that the pattern component image is displayed in a block detected as the degradation estimation region in the detection step when an image based on the pattern image data is displayed by the image display apparatus.

The present invention in its fourth aspect provides

an image display method for image display in an image display apparatus in which an emission brightness of a backlight can be controlled for each block obtained by dividing a screen,

the method comprising:

a detection step in which a computer detects a block in which display quality is estimated to be degraded, from among the blocks, as a degradation estimation region; and

a display control step in which the computer displays a pattern component image for inspecting display quality in block detected as the degradation estimation region in the detection step.

In accordance with the present invention, the degradation state of an image display apparatus can be inspected with good accuracy.

Further features of the present invention will become apparent from the following description of exemplary embodiments with reference to the attached drawings.

### BRIEF DESCRIPTION OF THE DRAWINGS

FIG. 1A illustrates an example of the configuration of the medical image display system according to Embodiment 1;

FIG. 1B illustrates an example of the configuration of the monitor for medical image display according to Embodiment 1;

FIG. 2 illustrates an example of the software configuration of the control unit according to Embodiment 1;

FIG. 3 illustrates an example of accumulated light-up time information according to Embodiment 1;

FIG. 4 illustrates an example of a processing flow in the degradation estimation region detection unit according to Embodiment 1;

FIGS. 5A to 5C illustrate examples of degradation estimation region information according to Embodiment 1;

FIG. 6 illustrates an example of a processing flow in the pattern image generating unit according to Embodiment 1;

FIGS. 7A and 7B illustrate examples of pattern component images according to Embodiment 1;

FIG. 8 illustrates an example of the pattern image according to Embodiment 1;

FIG. 9 illustrates an example of a processing flow in the pattern image generating unit according to Embodiment 2;

FIG. 10 illustrates an example of the pattern component image according to Embodiment 2;

FIGS. 11A to 11D illustrate examples of pattern images according to Embodiment 2;

FIG. 12 illustrates an example of a processing flow in the degradation estimation region detection unit according to Embodiment 3;

FIG. 13 illustrates an example of degradation estimation region information according to Embodiment 3;

FIG. 14 illustrates an example of degradation estimation region information according to Embodiment 5;

FIG. 15 illustrates an example of a processing flow in the pattern image generating unit according to Embodiment 5;

FIG. 16 illustrates an example of the pattern component image according to Embodiment 5;

FIGS. 17A to 17E illustrate examples of pattern images according to Embodiment 5;

FIG. 18 illustrates an example of degradation estimation region information according to Embodiment 6;

FIG. 19 illustrates an example of a processing flow in the pattern image generating unit according to Embodiment 6;

FIG. 20 illustrates an example of the pattern component image according to Embodiment 6;

FIG. 21 illustrates an example of the pattern image according to Embodiment 6;

FIG. 22 illustrates an example of pattern image for visual inspection defined by the guidelines;

FIG. 23 illustrates an example of the configuration of a backlight having a LD function;

FIGS. 24A to 24C shows a display example of a diagnostic image obtained during mammographic diagnostic;

FIG. 25 illustrates problems inherent to conventional techniques; and

FIGS. 26A and 26B shows display examples of pattern component images in a degradation region and a non-degradation region.

### DESCRIPTION OF THE EMBODIMENTS

### Embodiment 1

An image generating apparatus, an image display apparatus, an image generating method, and an image display method according to Embodiment 1 of the present invention are described below. The image generating apparatus according to the pre sent embodiment generates pattern image data including a pattern component image that is viewed by the user for inspecting the display quality of the image display apparatus (monitor).

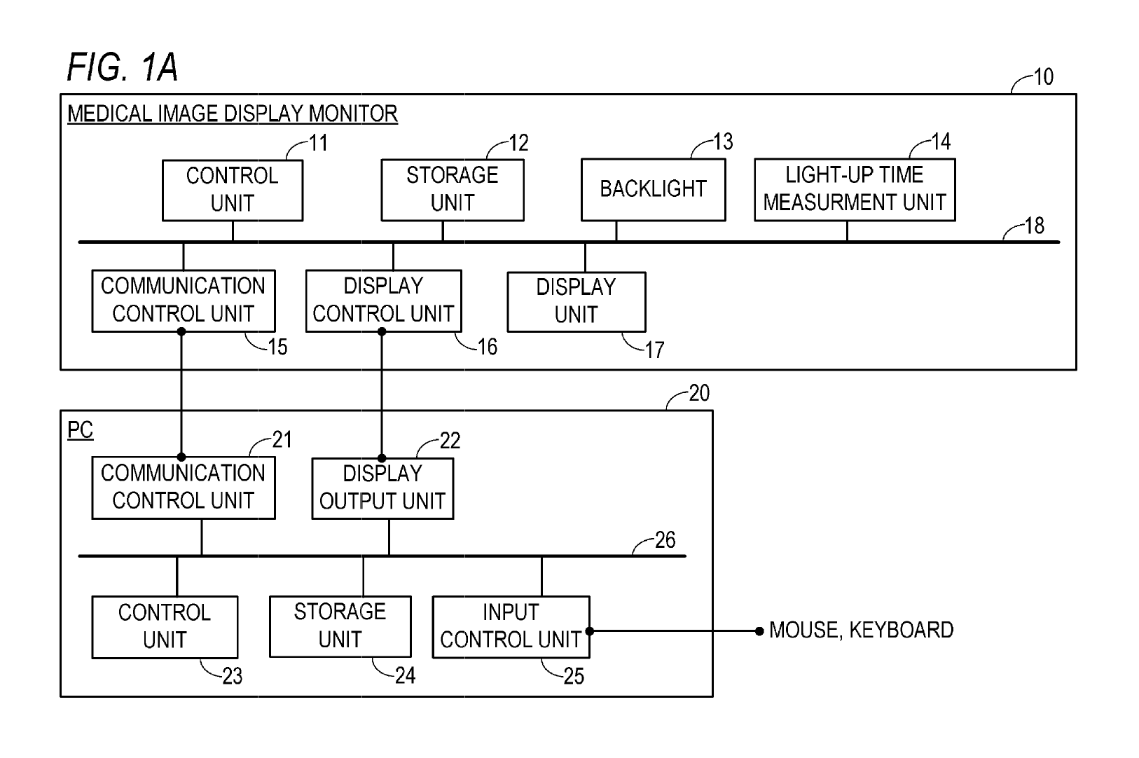

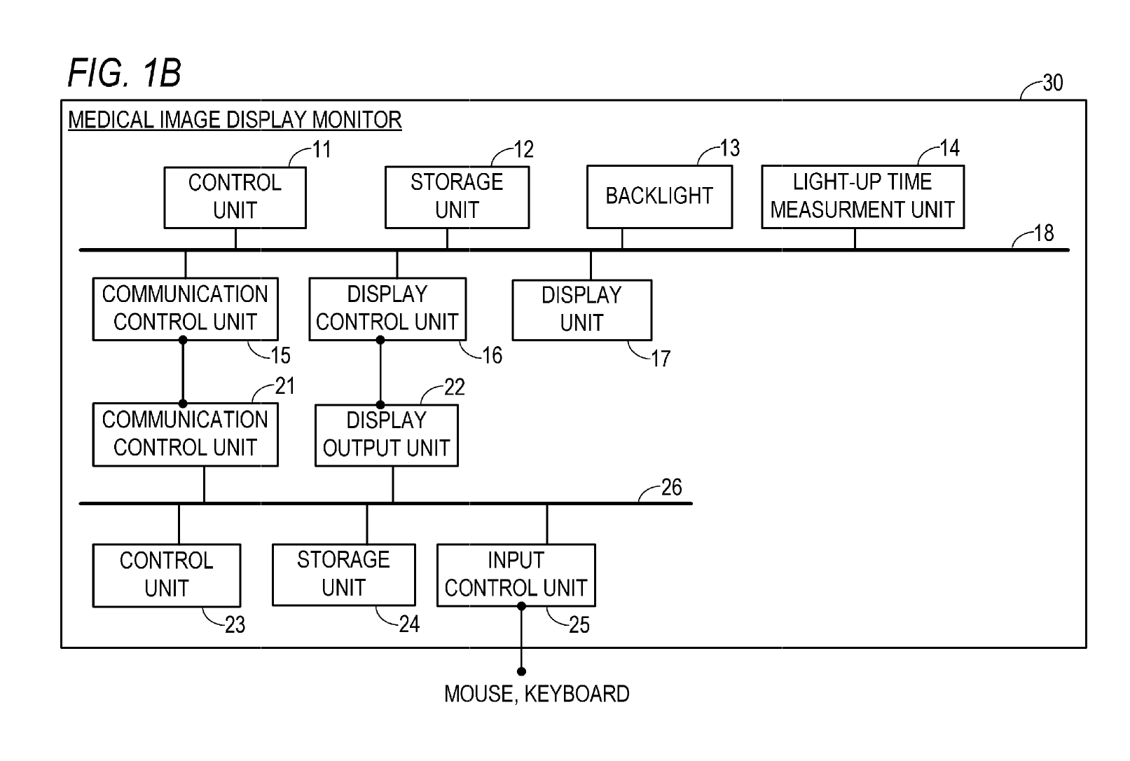

FIG. 1A illustrates an example of the configuration of the medical image display system according to Embodiment 1.

The medical image display system shown in FIG. 1A is constituted by a medical image display monitor 10 (referred to hereinbelow as “monitor 10”) and a PC 20 (image generating apparatus). However, the apparatus configuration in which the monitor and PC are integrated, as in the medical image display monitor 30 (image generating apparatus) shown in FIG. 1B, may be also used.

The configuration of the monitor 10 is explained below.

The monitor 10 is a liquid crystal display apparatus in which the emission brightness of the backlight can be controlled for each block obtained by dividing the screen region.

A control unit 11, a storage unit 12, a backlight 13, a light-up time measurement unit 14, a communication control unit 15, a display control unit 16, and a display unit 17 can communicate with each other via a bus 18.

The control unit 11 controls the functions of the monitor 10 via the bus 18. The control unit 11 is, for example, a CPU.

The storage unit 12 stores the below-described accumulated light-up time information. The storage unit 12 is, for example, a RAM.

The backlight 13 lights up, with the emission brightness of the backlight in the local region of the screen being adjusted by an LD (local dimming) function. For example, the backlight 13 determines the emission brightness on the basis of the displayed image signal for each block and lights up (emits light) at the determined emission brightness.

The light-up time measurement unit 14 measures for each block the preceding light-up time (accumulated light-up time) of the backlight of the block and stores the information on the accumulated light-up time (accumulated light-up time information) of each block in the storage unit 12. The accumulated light-up time may be the time since the monitor 10 was initially started, or in the case where the display quality has been adjusted, the time since the adjustment.

The communication control unit 15 performs communication with the PC 20. More specifically, the communication control unit 15 transmits the accumulated light-up time information stored in the storage unit 12 to the PC 20 via a USB cable. The cable for use in the communication is not limited to the USB cable. The communication may be also wireless communication.

The display control unit 16 outputs the image signal inputted from the PC 20 to the display unit 17. The display control unit 16 is, for example, connected to the PC 20 by an image signal cable such as DVI or Display Port.

The display unit 17 is a liquid crystal panel having a plurality of liquid crystal elements, the transmissivity thereof being controlled on the basis of image signals inputted from the display control unit 16. As a result of the light from the backlight 13 being transmitted by the display unit 17, an image is displayed on the display surface (screen) of the display unit 17. In the present embodiment, the display unit 17 has a resolution of 2048 [pixel] (width) by 1536 [pixel] (height). However, this resolution of the display unit 17 is not limiting.

The bus 18 is connected to each function of the monitor 10 and enables communication between the functions of the monitor 10.

The configuration of the PC 20 is explained below.

A communication control unit 21, a display output unit 22, a control unit 23, a storage unit 24, and an input control unit 25 can communicate with each other via a bus 26.

The communication control unit 21 performs communication with the monitor 10. More specifically, the communication control unit transmits the accumulated light-up time information acquired from the monitor 10 to the control unit 23.

The display output unit 22 outputs pattern image data generated by the control unit 23 to the monitor 10. More specifically, the display output unit 22 converts the pattern image data into image signals and outputs the image signals to the monitor 10.

The control unit 23 controls the functions of the PC 20 via the bus 26. The control unit 23 also detects a block in which display quality is estimated to be degraded, from among the divided regions of the monitor 10, as a degradation estimation region by using the accumulated light-up time information acquired from the monitor 10 and generates pattern image data from the pattern component images stored in the storage unit 24 on the basis of the detection result. Functions of the control unit 23 are described below in greater detail. The control unit 23 is, for example, a CPU (computer) and realizes processing of various types by executing a program stored on a recording medium (computer-readable recording medium) such as a memory.

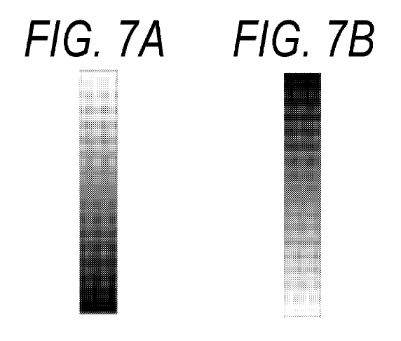

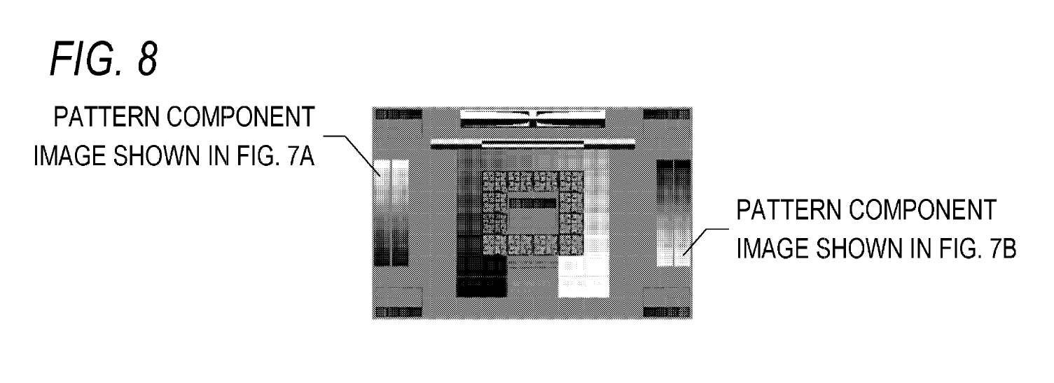

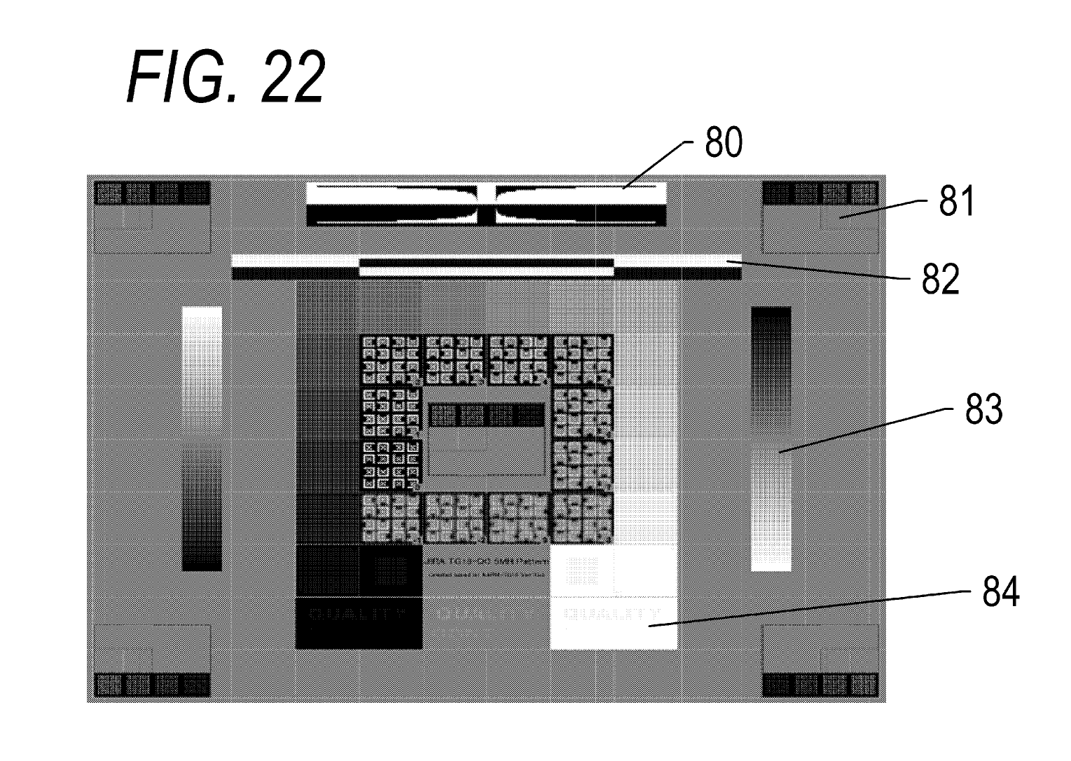

The storage unit 24 stores pattern image (FIG. 22) or pattern component images (FIGS. 7A, 7B, 10, 16, and 20). An optical disk such as DVD and BluRay disk, a magnetic disk such as a hard disk, and a semiconductor memory such as a RAM can be used as the storage unit 24. The image data stored in the storage unit 24 is referred to by the control unit 23 according to the processing and expanded in a graphics memory. The pattern component images shown in FIGS. 7A and 7B are partial images of the pattern image for visual inspection (JIRA TG18-QC) defined by the guidelines.

The input control unit 25 receives input of operation information representing user's operations (operations of the PC 20 by the user) from a mouse or a keyboard and outputs the same to the control unit 23.

The bus 26 is connected to each function of the PC 20 and enables communication between the functions of the PC 20.

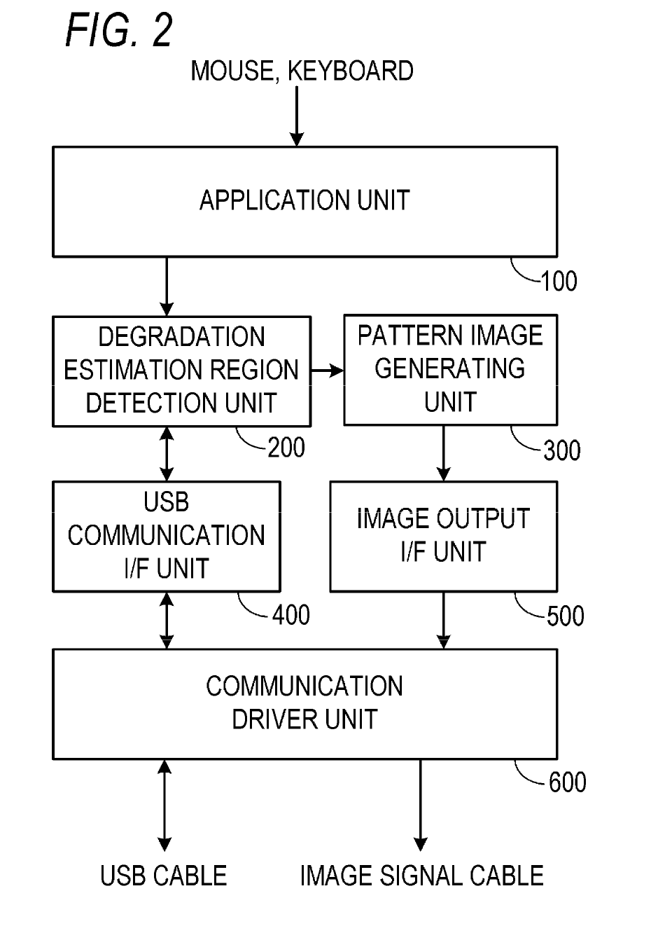

FIG. 2 is a software block diagram illustrating an example of software configuration of the control unit 23. An application unit 100 acquires operation information from the mouse or keyboard via the input control unit 25 and performs control corresponding to the operation information. For example, when a predetermined button is pushed on the GUI screen by the user, the application unit 100 notifies a degradation estimation region detection unit 200 of the start of inspection (visual inspection) of display quality of the monitor 10.

The degradation estimation region detection unit 200 acquires the accumulated light-up time information from an USB communication I/F unit 400 and detects a degradation estimation region by using the acquired accumulated light-up time information. More specifically, the degradation estimation region detection unit 200 compares the accumulated light-up time of a block with a reference time for each block and determines the degradation estimation region. In the present embodiment, the degradation estimation region detection unit 200 detects a block for which the accumulated light-up time is equal to or longer than a reference time as the degradation estimation region. The reference time may be a value that has been set in advance by the manufacturer or user, or may be a value calculated when the processing of detecting the degradation estimation region is performed. The reference time may be a fixed time stored, for example, in a ROM (not shown in the figure) in the PC 20, or a value that can be changed by the user by using the GUI screen or the like.

The degradation estimation region detection unit 200 then transmits the information representing the degradation estimation region (degradation estimation region information) to a pattern image generating unit 300.

In the present embodiment, the accumulated light-up time is an accumulated light-up time in which the backlight was lit up with an emission brightness equal to or higher than a predetermined value. For example, the accumulated light-up time is an accumulated light-up time in which the backlight was lit up with the maximum emission brightness or an emission brightness equal to or greater than 90%, where the maximum emission brightness is taken as 100%. The degradation estimation region may be also detected by using not only the accumulated light-up time information, but also the emission brightness value information. For example, the accumulated light-up time of lighting up in a first emission brightness value region (100% to 66%), the accumulated light-up time of lighting up in a second emission brightness value region (66% to 33%), and the accumulated light-up time of lighting up in a third emission brightness value region (33% to 0%) may be added up after weighting with weighting factors corresponding to the emission brightness values. The accumulated light-up time obtained by the weighted addition may be compared with the reference time.

Further, the degradation estimation region detection unit 200 may be configured to detect the degradation estimation region on the basis of the detected value of an optical sensor detecting light from the backlight (emission brightness of the backlight), without using the accumulated light-up time information. For example, a configuration may be used in which the degradation estimation region is detected on the basis of a difference in brightness between the initial detection value and the present detection value of the backlight emission brightness. Since the backlight brightness gradually decreases due to degradation with time, it is possible to estimate that a probability of display quality degradation is high as the difference in brightness increases. Therefore, a block with the difference in brightness equal to or higher than a predetermined value (for example, 40%), may be detected as a degradation estimation region.

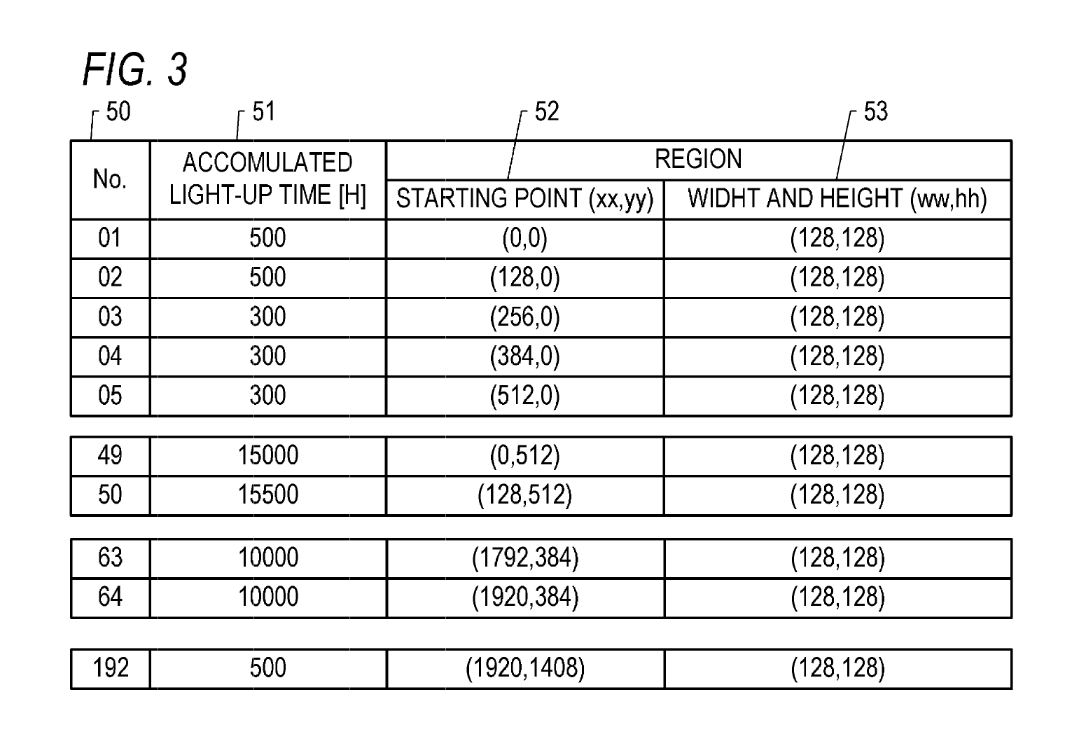

A specific example of accumulated light-up time information is explained below with reference to FIG. 3.

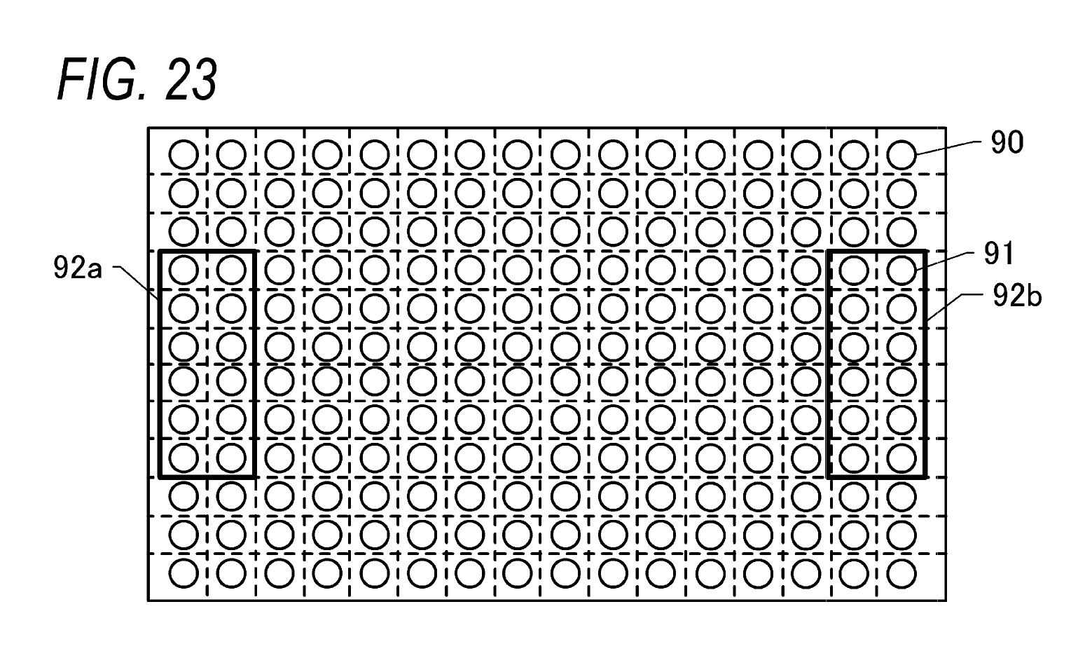

An identifiable unique number is individually allocated to the backlight of each block. More specifically, the backlight 13 has the configuration shown in FIG. 23 (each region produced by broken lines is a block). A plurality of light sources 90 can be individually controlled (that is, the backlight of one block is one light source). Numbers of No.=01, 02, 03, . . . (light source number; block number) are allocated in the order from the upper left corner to the lower right corner to the plurality of light sources 90.

The accumulated light-up time information includes the accumulated light-up time and region information for each block.

More specifically, the accumulated light-up time information is constituted by a light source number (reference numeral 50), an accumulated light-up time (reference numeral 51), block starting point coordinates (xx, yy) [pixel] (reference numeral 52), and block width and height (ww, hh) [pixel] (reference numeral 53).

In the example shown in FIG. 3, the light source with No.=01 is a backlight of a region (block) with (width 128, height 128) [pixel] that has an accumulated light-up time of 500 [H] and a coordinate (0, 0) [pixel] of the screen region of the monitor 10 as a starting point. The accumulated light-up time information is assumed to include such information relating to all of the blocks.

FIGS. 3 and 23 show the case in which the backlight of one block is one light source, but the backlight of one block may be a plurality of light sources. In this case, the accumulated light-up time information is information including, for example, coordinates of the block and the accumulated light-up time for a plurality of light sources which constitute the backlight of the block for each block.

The pattern image generating unit 300 generates pattern image data by using the degradation estimation region information acquired from the degradation estimation region detection unit 200 and the pattern component image (FIGS. 7A and 7B) expanded in the RAM in the PC 20. More specifically, the pattern image generating unit 300 generates pattern image data such that the pattern component image is displayed in a block detected as a degradation estimation region by the degradation estimation region detection unit 200 when the image based on the pattern image data is displayed by the monitor 10. The generated pattern image data is outputted to an image output I/F unit 500.

The USB communication I/F unit 400 has an I/F function of acquiring the accumulated light-up time information from a communication driver unit 600 and outputting the acquired information to the degradation estimation region detection unit 200.

The image output I/F unit 500 has an I/F function of acquiring the pattern image data from the pattern image generating unit 300 and outputting the acquired data to the communication driver unit 600.

The communication driver unit 600 has a driver function necessary for communicating (outputting the pattern image data to the monitor 10 and acquiring the accumulated light-up time information from the monitor 10) with the monitor 10 via the communication control unit 21 or the display output unit 22.

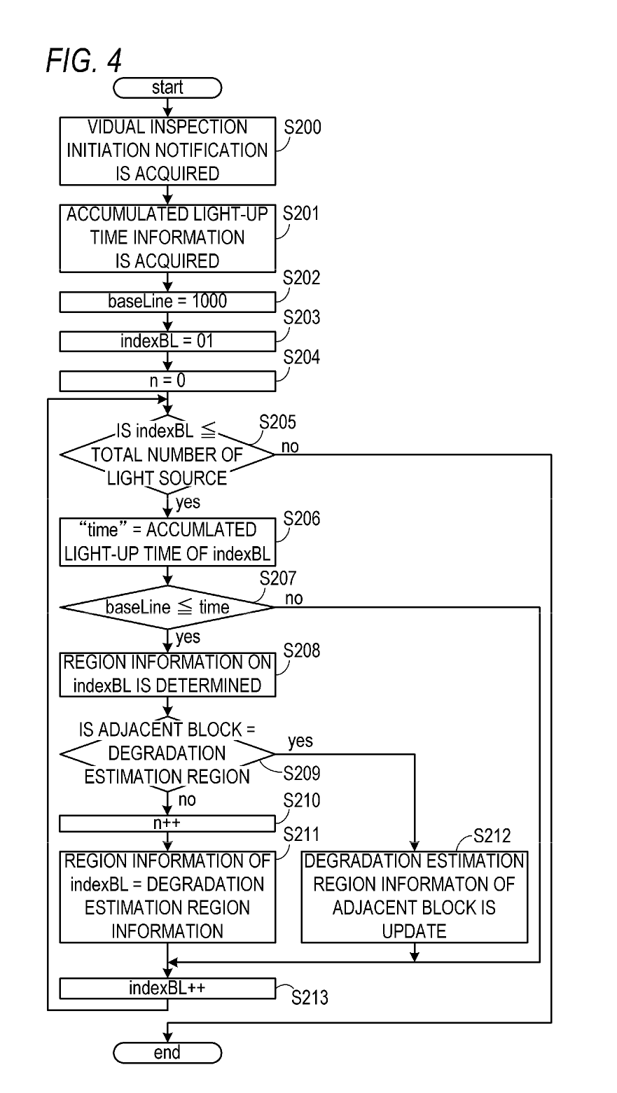

The details of the processing performed by the degradation estimation region detection unit 200 will be described with reference to the processing flowchart shown in FIG. 4.

In S200, the degradation estimation region detection unit 200 acquires a notification about the start of visual inspection from the application unit 100. Thus, the processing following S201 is performed by using the notification about the start of visual inspection from the application unit 100 as a trigger.

In S201, the degradation estimation region detection unit 200 acquires the accumulated light-up time information.

In S202, the degradation estimation region detection unit 200 assigns a reference time (threshold) of the accumulated light-up time that is used for determining the degradation estimation region to a baseLine. In the present embodiment, it is assumed that baseLine=1000 [H]. In S203, the degradation estimation region detection unit 200 sets a light source number (reference numeral 50 in FIG. 3) of the light source of the block that is the object of processing performed to determine the degradation estimation region to indexBL. In this case, indexBL=01.

In S204, the degradation estimation region detection unit 200 initializes the number n of degradation estimation region to 0. In this case, n is a variable indicating the total number of discretely-positioned degradation estimation regions that have been detected by the degradation estimation region detection unit 200.

In S205, the degradation estimation region detection unit 200 compares indexBL with the total number of light sources (total number of blocks; 192 in the present example), and where indexBL is equal to or less than the total number of light sources (S205: yes), the processing is advanced to S206.

In S206, the degradation estimation region detection unit 200 refers to the accumulated light-up time information and assigns the value of the accumulated light-up time of indexBL to a variable “time”. Where the accumulated light-up time information is the information shown in FIG. 3, “time”=500 when indexBL=01.

In S207, the degradation estimation region detection unit 200 determines whether or not the accumulated light-up time of indexBL is equal to or greater than the reference time baseLine.

Where the accumulated light-up time of indexBL is less than the reference time baseLine (S207: no), the block of indexBL is determined not to be the degradation estimation region, and the processing is advanced to S213. Where the accumulated light-up time of indexBL is equal to or greater than the reference time baseLine (S207: yes), the block of indexBL is determined to be the degradation estimation region, and the processing is advanced to S208.

In S208, the degradation estimation region detection unit 200 determines region information (starting point, width, height) of the block corresponding to the backlight of indexBL from the accumulated light-up time information acquired in S201. For example, when indexBL=49, “time”=15000 [H]≧0 baseLine and therefore it is determined that the starting point (xx, yy)=(128, 0) and (width ww, height hh)=(128, 128).

In the present example, the degradation estimation regions that are mutually adjacent are identified as one region. Therefore, the processing of S209 is performed after S208.

In S209, by using the region information of the blocks, the degradation estimation region detection unit 200 determines whether a block adjacent to the indexBL block is present among the blocks that have already been determined as the degradation estimation regions.

When a block adjacent to the indexBL block is present among the blocks that have already been determined as the degradation estimation regions (S209: yes), the processing is advanced to S212.

When a block adjacent to the indexBL block is not present among the blocks that have already been determined as the degradation estimation regions (S209: no), the processing is advanced to S210.

In S210, the degradation estimation region detection unit 200 adds 1 to the number n of degradation estimation regions. Then, in S211, the degradation estimation region detection unit 200 stores the region information representing the indexBL block as degradation estimation region information. The processing then advances to S213.

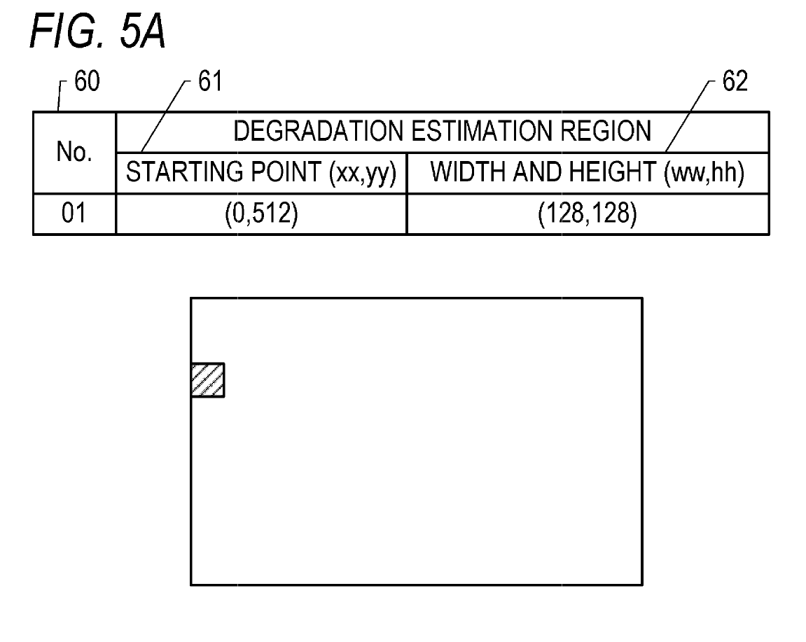

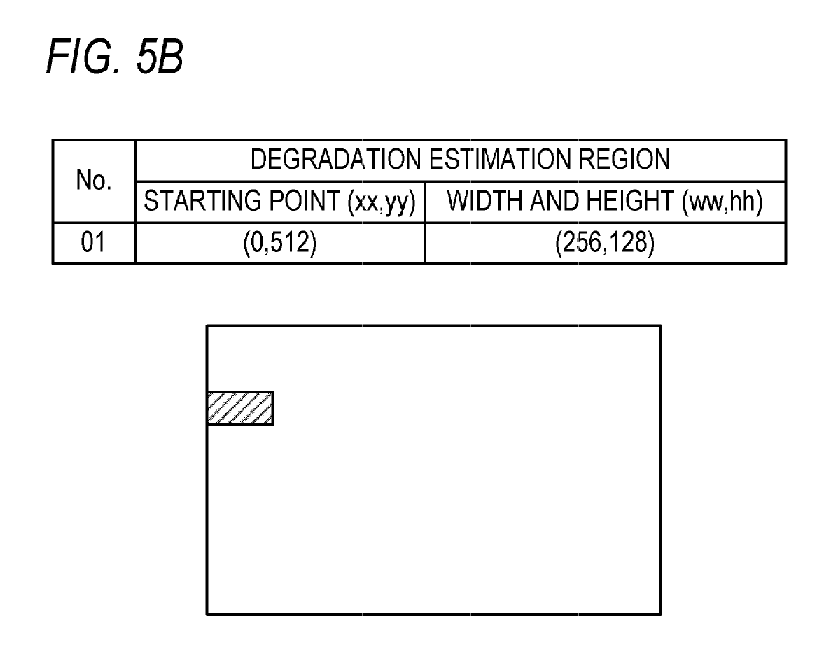

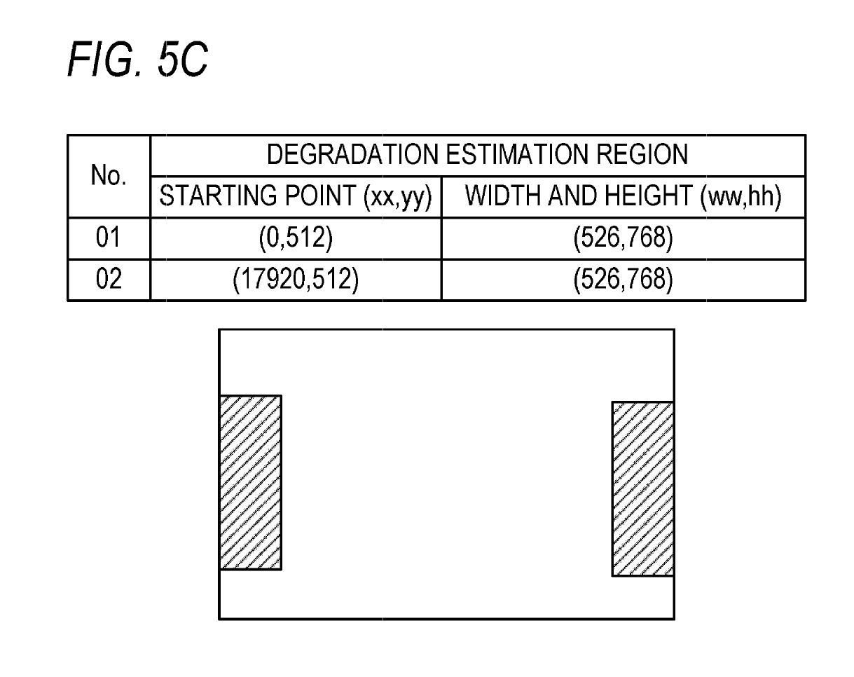

An example of the degradation estimation region information will be explained be low in detail with reference to FIGS. 5A to 5C. The degradation estimation region information is constituted by a region number (reference numeral 60), starting point coordinates (xx, yy) [pixel] (reference numeral 61) of the degradation estimation region, and width and height (ww, hh) [pixel] (reference number 62) of the degradation estimation region. The rectangular hatched sections shown in FIGS. 5A to 5C represent the degradation estimation regions of the monitor.

In the case where the “no” determination is made for the first time in S207 when indexBL=49, as shown in FIG. 5A, (xx, yy)=(0, 512), (ww, hh)=(128, 128) are newly stored as the degradation estimation region with the degradation estimation region number=01.

In S212, the degradation estimation region detection unit 200 updates the degradation estimation region information on the block that has been determined in S209 to be adjacent to the indexBL block to the information on the region including the indexBL block. Then the processing is advanced to S213.

In the case where the “no” determination has been made in S207 with respect to the block with indexBL=50 after the block with indexBL=49 has been taken as the degradation estimation region, the degradation estimation region information with the degradation estimation region number=01 is updated as shown in FIG. 5B. More specifically, the degradation estimation region information with the degradation estimation region number 01 is updated to information on the region including the blocks with indexBL=49 and 50. Thus, the width represented by the region information with indexBL=50 is added to the width with the degradation estimation region number=01, and the width and height with the degradation estimation region number=01 are taken as (ww, hh)=(256, 128).

In S213, the degradation estimation region detection unit 200 adds 1 to indexBL and the processing returns to S205. Then, after the processing of S205 to S213 has been repeatedly executed with respect to all of the light sources (all of the blocks), the “no” determination is made in S205, and the present flow is ended.

In the present embodiment, it is assumed that the information shown in FIG. 5C is obtained as the degradation estimation region information as a result of repeatedly performing the processing of S205 to S213 with respect to all of the light sources (all of the blocks). Thus, in the present embodiment, it is assumed that information representing the two regions is acquired as the degradation estimation region information. More specifically, it is assumed that the information representing the region with (xx, yy)=(0, 512), (ww, hh)=(526, 768) and the region with (xx, yy)=(17920, 512), (ww, hh)=(526, 768) is acquired.

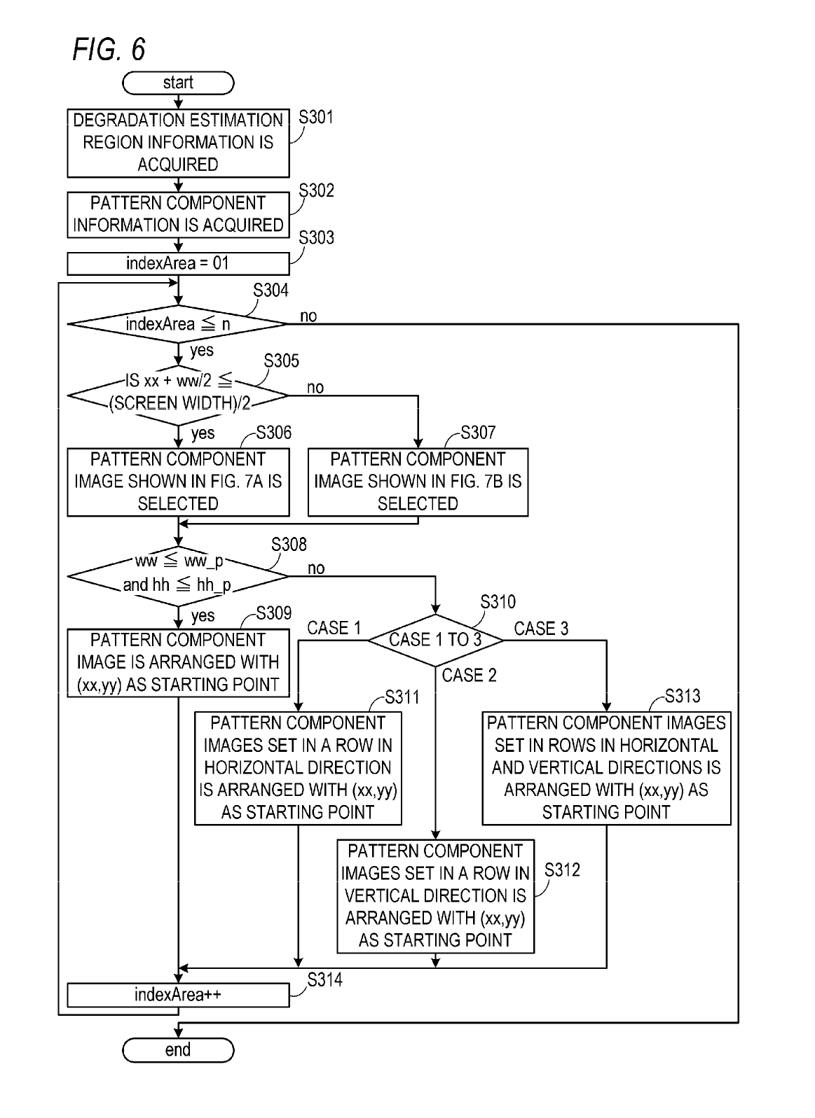

The details of the processing performed by the pattern image generating unit 300 will be explained below with reference to the processing flowchart shown in FIG. 6.

In S301, the pattern image generating unit 300 acquires the degradation estimation region information (FIG. 5C) from the degradation estimation region detection unit 200.

In S302, the pattern image generating unit 300 refers to image data expanded to the RAM and acquires pattern component information. The pattern component information, as referred to herein, is data (image contents, width, height) on the pattern component image shown in FIGS. 7A and 7B. In the present embodiment, it is assumed that the width of the pattern component image shown in FIGS. 7A and 7B is ww_p=300 [pixel] and the height is hh_p=800 [pixel].

In S303, the pattern image generating unit 300 sets the degradation estimation region number indexArea=01. In this case, the indexArea is a variable indicating the degradation estimation region number (reference numeral 60 in FIG. 5A).

In S304, the pattern image generating unit 300 compares the indexArea with the number n of degradation estimation regions (in the present embodiment, n=2), and when the indexArea is equal to or less than the number n of degradation estimation regions (S304: yes), the processing is advanced to S305.

In S305, the pattern image generating unit 300 determines whether or not the region represented by the degradation estimation region number indexArea is positioned to the left of the central position of the screen. More specifically, when the width of the entire screen in the horizontal direction is 2048 [pixel], the pattern image generating unit 300 determines whether or not the value obtained by adding ½ of the width ww to the horizontal coordinate value xx of the starting point of the degradation estimation region is equal to or less than 1024.

When the region represented by the degradation estimation region number indexArea has been determined to be positioned to the left of the central position of the screen (S305: yes), the pattern image generating unit 300 selects in S306 the pattern component image shown in FIG. 7A.

When the region represented by the degradation estimation region number indexArea has been determined to be positioned to the right of the central position of the screen (S305: no), the pattern image generating unit 300 selects in S307 the pattern component image shown in FIG. 7B.

In S308, the pattern image generating unit 300 determines whether or not the width ww and height hh of the region with the degradation estimation region number indexArea are respectively equal to or lower than the width ww_p and height hh_p of the selected pattern component image.

When the width ww and height hh are equal to or lower than the width ww_p and height hh_p, respectively, (S308: yes), the processing is advanced to S309; otherwise (S308: no), the processing is advanced to S310.

In S310, the pattern image generating unit 300 determines which of the following cases 1 to 3 is realized. In case 1, the width ww is larger than the width ww_p, and the height hh is equal to or less than the height hh_p. In case 2, the width ww is equal to or less than the width ww_p, and the height hh is greater than the height hh_p. In case 3, the width ww is larger than the width ww_p, and the height hh is larger than the height hh_p. When case 1 is realized, the processing is advanced to S311. When case 2 is realized, the processing is advanced to S312. When case 3 is realized, the processing is advanced to S313.

In S309, the pattern image generating unit 300 generates (updates) the pattern image such that the selected pattern component image with (xx, yy) as the starting point is displayed.

In S311, the pattern image generating unit 300 generates pattern image such that the number of selected pattern component images with (xx, yy) as the starting point that are displayed in the horizontal direction is equal to ww/ww_p. In the present embodiment, the width and height (ww, hh) of the degradation estimation region with indexArea=01 are (526, 768) and the width and height (ww_p, hh_p) of the pattern component image are (300, 800). Therefore, the pattern image is generated such that the number of pattern component images with (xx, yy)=(0, 512) as a starting point that are displayed in the horizontal direction is ww/ww_p=2 (FIG. 8).

In S312, the pattern image generating unit 300 generates pattern image such that the number of selected pattern component images with (xx, yy) as the starting point that are displayed in the vertical direction is equal to hh/hh_p.

In S313, the pattern image generating unit 300 generates pattern image such that the number of selected pattern component images with (xx, yy) as the starting point that are displayed in the horizontal and vertical directions is ww/ww_p and hh/hh_p, respectively.

Following the processing of S309 to S313, the processing is advanced to S314.

In S314, the pattern image generating unit 300 adds 1 to the indexArea and returns the processing to S304. After the processing of S304 to S314 has been repeatedly performed with respect to all of the degradation estimation regions, the “no” determination is made in S304 and the present flow is ended.

During the visual inspection, the pattern image (FIG. 8) generated in the pattern image generating unit 300 is displayed after the pattern image for visual inspection (FIG. 22, JIRA TG18-QC pattern) defined by the guidelines has been displayed. Alternatively, the pattern image (FIG. 8) generated by the pattern image generating unit 300 is displayed instead of the pattern image for visual inspection (FIG. 22) defined by the guidelines. The pattern image shown in FIG. 8 is obtained by partially changing the pattern image for visual inspection (JIRA TG18-QC) defined by the guidelines.

The pattern image shown in FIG. 22 may be displayed after the pattern image shown in FIG. 8 has been displayed.

As described hereinabove, in accordance with the present embodiment, a degradation estimation region which is estimated to have the degraded display quality is detected, and pattern image data are generated such that the pattern component image is displayed in the degradation estimation region. As a result, the degradation state of the image display apparatus can be inspected with good accuracy. More specifically, even when the degradation of display quality that the degradation state of some regions of the screen is different from that of other regions has occurred due to LD function, the degradation state of the image display apparatus can be inspected with good accuracy.

Further, in the present embodiment, the PC 20 has the degradation estimation region detection unit 200 and the pattern image generating unit 300. In other words, an example is described in which the image generating apparatus is separated from the image display apparatus, but such a configuration is not limiting. Thus, the monitor 10 may have the degradation estimation region detection unit 200 and the pattern image generating unit 300. In other words, a configuration may be used in which the image generating apparatus and the image display apparatus are integrated.

Further, in the present embodiment, the case is explained in which the image display apparatus is a monitor for displaying medical images, but the image display apparatus is not limited to such a configuration. Thus, a monitor having the LD function may be used. Moreover, in the present embodiment, a case is explained in which the image display apparatus is a liquid crystal display apparatus, but the image display apparatus is not limited to liquid crystal display apparatuses. The image display apparatus may be an image display apparatus having an independent light source (backlight).

Further, in the present embodiment, visual inspection is presumed, but the pattern image created in the present embodiment may be also used for measurement inspection. When the measurement inspection is performed, the pattern image (FIG. 22) for visual inspection defined by the guidelines is not displayed, and the pattern image (FIG. 8) generated in the pattern image generating unit 300 is displayed. The brightness of the pattern image is then measured by using a brightness meter provided in the monitor 10 or connected to the monitor 10 or PC 20, and the inspection of the degradation estimation region is performed.

### Embodiment 2

The image generating apparatus, image display apparatus, image generating method, and image display method according to Embodiment 2 of the present invention are described below. Functions different from those of Embodiment 1 are described hereinbelow in detail, and the explanation of functions same as those of Embodiment 1 is omitted.

In the present embodiment, the processing performed by the pattern image generating unit 300 is different from that of Embodiment 1.

In Embodiment 1, the pattern image generating unit 300 generates one pattern image data, whereas in the present embodiment, the pattern image generating unit 300 generates a plurality of pattern image data.

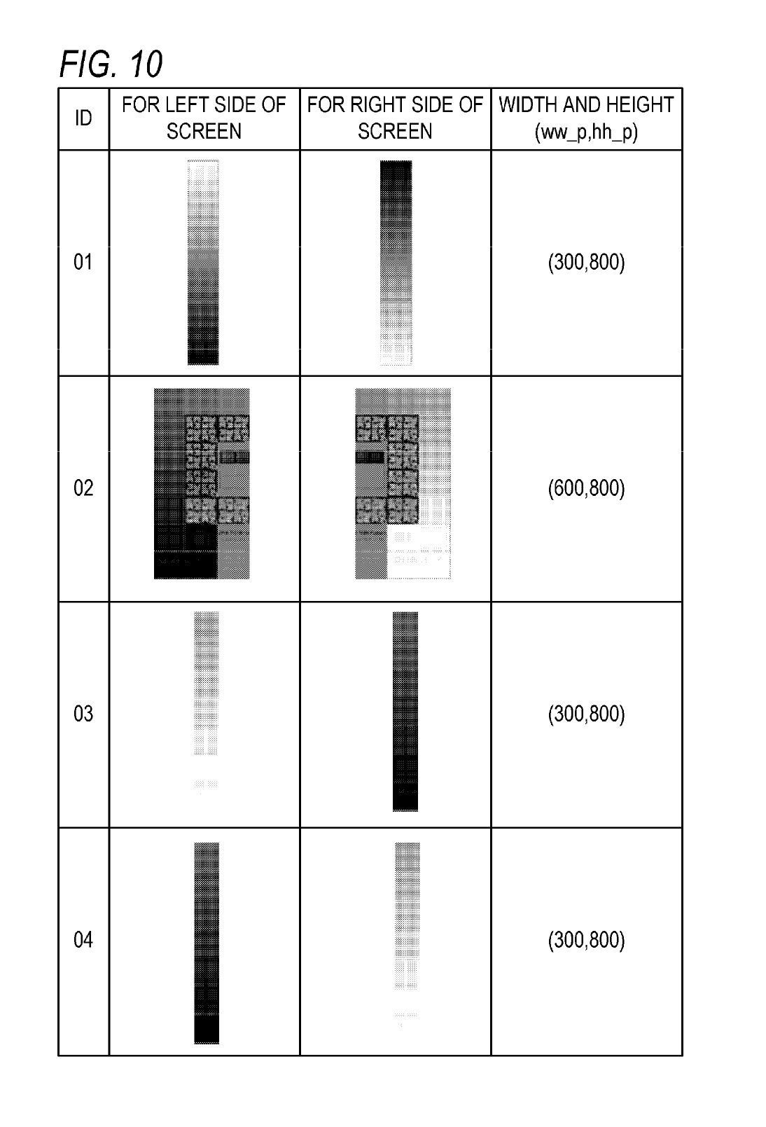

More specifically, in the present embodiment, it is assumed that data on a plurality of pattern component images of different types, such as shown in FIG. 10, is expanded to the RAM in the PC 20. The data of the pattern component images is managed by individually identifiable ID numbers. More specifically, the numbers ID=01, 02, 03, 04 are associated with the plurality of pattern component images. Further, data of two types, namely, for the left and right sides of the screen, is assumed to be stored as the data on the pattern component images of the same type. The pattern component images shown in FIG. 10 are part of the pattern image (JIRA TG18-QC) for visual inspection defined by the guidelines.

The pattern image generating unit 300 generates a plurality of pattern image data with different types of pattern component images.

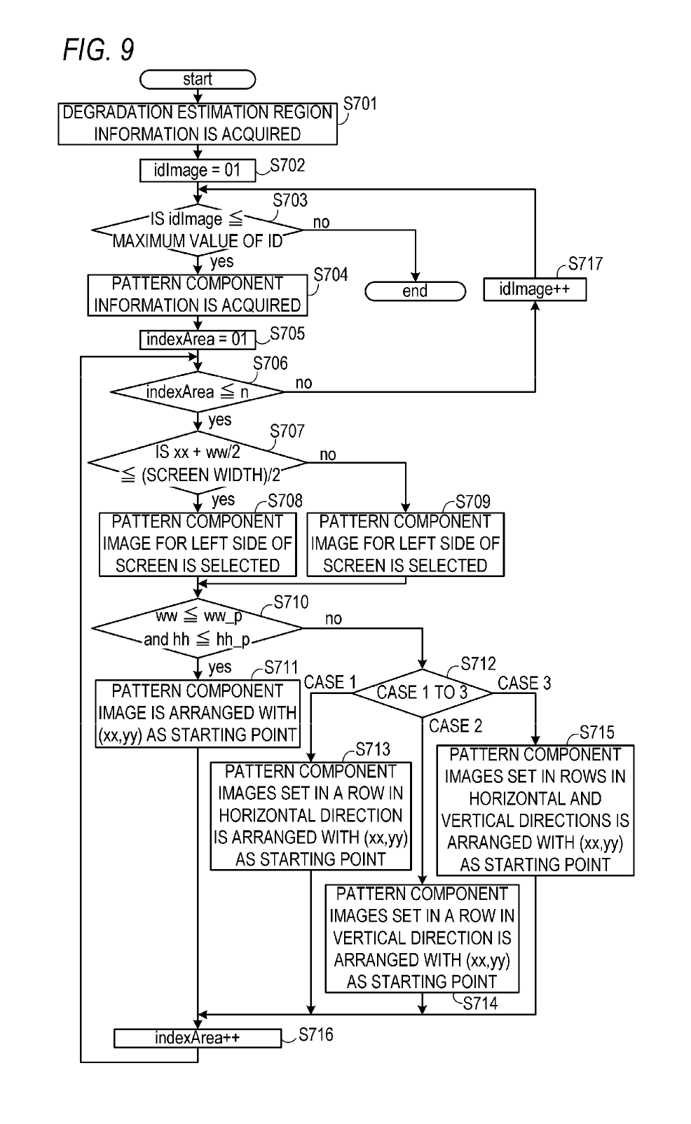

The details of the processing performed by the pattern image generating unit 300 are described below with reference to the processing flowchart shown in FIG. 9.

In S701, the pattern image generating unit 300 acquires degradation estimation region information from the degradation estimation region detection unit 200.

In S702, the pattern image generating unit 300 initializes to 01 a variable idImage specifying the ID of image data that will be referred to, from among the data on the pattern component images expanded to the RAM. In this case, the idImage is a variable indicating the ID identifying the pattern component image stored in the PC 20.

In S703, the pattern image generating unit 300 compares the idImage with the maximum value (4 in the present embodiment) of ID, and when the idImage is equal to or less than the maximum value of ID (S703: yes), the processing is advanced to S704. The processing of S704 to S716 is the same as the processing of S302 to S314 shown in FIG. 6 and the explanation thereof is herein omitted.

Where the generation of pattern image data using the pattern component image with ID=idImage is ended, in S717, the pattern image generating unit 300 adds 1 to the idImage and returns the processing to S703. After the processing of S703 to S717 has been performed till idImage=a maximum value of ID is obtained, that is, till the pattern image data are generated with respect to all of the pattern component images, the “no” determination is made in S703 and the present processing flow is ended.

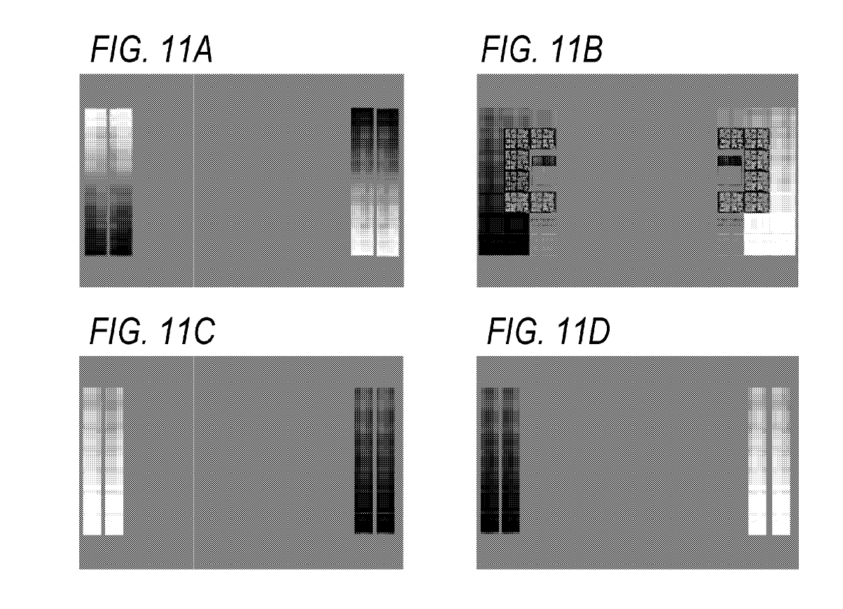

During the visual inspection, a plurality of pattern images (FIGS. 11A to 11D) that are generated in the pattern image generating unit 300 is successively displayed after the pattern image (FIG. 22) for visual inspection that is defined by the guidelines has been displayed. The pattern images (FIGS. 11A to 11D) generated in the pattern image generating unit 300 can be also successively displayed instead of the pattern image (FIG. 22) for visual inspection that are defined by the guidelines. The pattern image shown in FIG. 22 may be displayed after the pattern images shown in FIGS. 11A to 11D have been successively displayed.

As described hereinabove, according to the present embodiment, a plurality of pattern image data with different types of pattern component images is generated. As a result, when a plurality of pattern component images of different types (for example, a plurality of images that differ in information that can be visually obtained) is prepared, those images can be displayed and viewed in the degradation estimation region. As a result, the degradation state of the image display apparatus can be inspected with higher accuracy.

Further, in the present embodiment, visual inspection is presumed, but the pattern images created in the present embodiment may be also used for measurement inspection. When the measurement inspection is performed, the pattern image (FIG. 22) for visual inspection defined by the guidelines is not displayed, and a plurality of pattern images (FIGS. 11A to 11D) generated in the pattern image generating unit 300 is successively displayed. The brightness of the pattern images is then measured by using a brightness meter provided in the monitor 10 or connected to the monitor 10 or PC 20, and the inspection of the degradation estimation region is performed.

### Embodiment 3

The image generating apparatus, image display apparatus, image generating method, and image display method according to Embodiment 3 of the present invention are described below. Functions different from those of Embodiment 1 are described hereinbelow in detail, and the explanation of functions same as those of Embodiment 1 is omitted.

In the present embodiment, the processing performed by the degradation estimation region detection unit 200 and the pattern image generating unit 300 is different from that of Embodiment 1.

In Embodiment 1, one reference time is used, but in the present embodiment, the reference time includes a plurality of reference times, each having a different length. For example, a reference time 1 is set to 1000 [H] and a reference time 2 is set to 15000 [H].

The degradation estimation region detection unit 200 compares the accumulated light-up time with a plurality of reference times for each block. Then, with respect to at least some time ranges from among a plurality of time ranges determined by the plurality of reference times, a block in which the accumulated light-up time is within such time range is detected as a degradation estimation region for each time range. Further, in the present embodiment, a priority is set for each time range such that the priority is higher for a time range that is determined by a longer reference time.

For example, a block in which the accumulated light-up time is equal to or longer than the reference time 2 is detected as a degradation estimation region with a “HIGH” priority, and a block in which the accumulated light-up time is equal to or longer than the reference time 1 and less than a reference time 2 is detected as a degradation estimation region with a “MEDIUM” priority. A block in which the accumulated light-up time is less than the reference time 1 is not detected as a degradation estimation region.

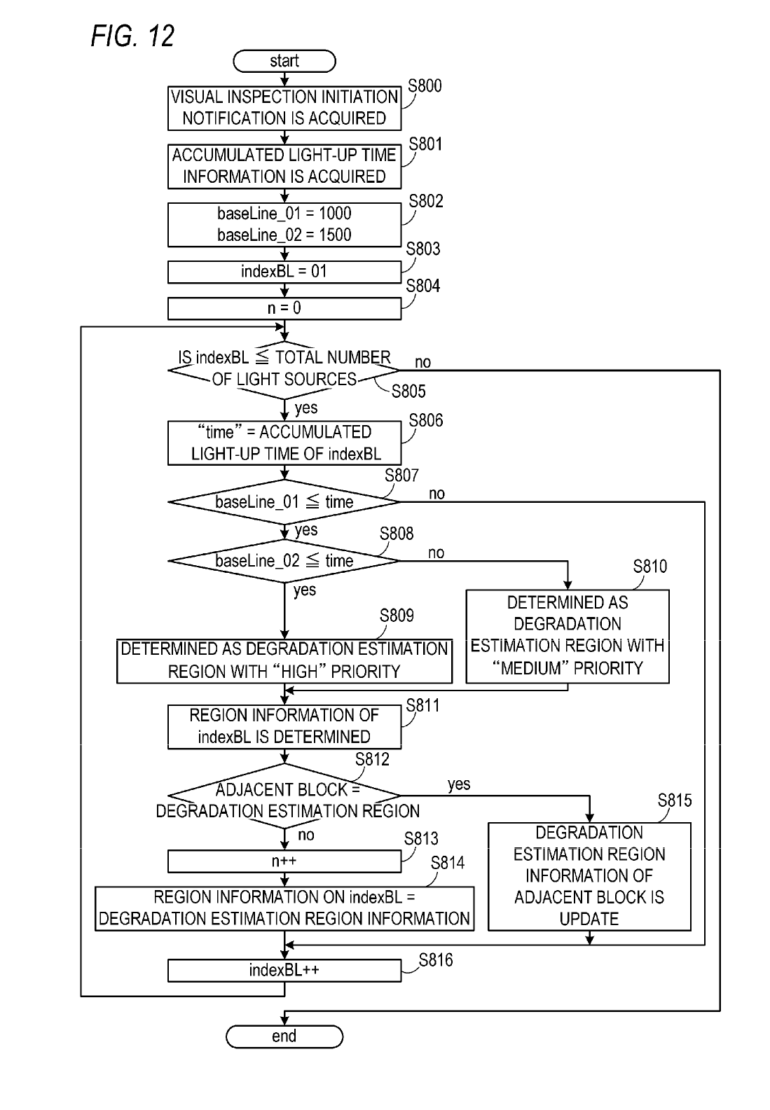

The details of the processing performed by the degradation estimation region detection unit 200 will be explained below with reference to the processing flowchart shown in FIG. 12.

The processing of S800 and S801 is the same that of S200 and S201 shown in FIG. 4 and the explanation thereof is herein omitted.

In S802, the degradation estimation region detection unit 200 sets a plurality of reference times. In the present embodiment, it is assumed that reference times of two types, namely, baseLine_{—}01=1000 and baseLine_{—}02=15000, are set.

The processing of S803 to S806 is the same that of S203 to S206 shown in FIG. 4 and the explanation thereof is herein omitted.

In S807, the degradation estimation region detection unit 200 determines whether or not the accumulated light-up time “time” of indexBL is equal to or greater than the baseLine_{—}01.

Where the accumulated light-up time “time” of indexBL is less than the baseLine_{—}01 (S807: no), the degradation estimation region detection unit 200 does not determine the indexBL block as a degradation estimation region and advances the processing to S816.

Where the accumulated light-up time “time” of indexBL is equal to or greater than the baseLine_{—}01 (S807: yes), in S808, the degradation estimation region detection unit 200 determines whether or not the accumulated light-up time “time” of indexBL is equal to or greater than the baseLine_{—}02.

Where the accumulated light-up time “time” of indexBL is equal to or greater than the baseLine_{—}02 (S808: yes), in S809, the degradation estimation region detection unit 200 determines the indexBL block as a degradation estimation region with a “HIGH” priority.

Where the accumulated light-up time “time” of indexBL is equal to or greater than the baseLine_{—}01 and less than the baseLine_{—}02 (S808: no), in S810, the degradation estimation region detection unit 200 determines the indexBL block as a degradation estimation region with a “MEDIUM” priority.

The processing of S811 to S813 is the same that of S208 to S210 shown in FIG. 4 and the explanation thereof is herein omitted. However, in S812, it is determined whether or not the blocks of degradation estimation regions with the same priority are adjacent to each other.

In S814 and S815, the degradation estimation region detection unit 200 stores the priority so that the priority is associated with the degradation estimation region information, in addition to the processing of S211 and S212 shown in FIG. 4. More specifically, the “HIGH” priority is associated with the degradation estimation region information representing the region including the block for which the accumulated light-up time is equal to or greater than baseLine_{—}02. The “MEDIUM” priority is associated with the degradation estimation region information representing the region including the block for which the accumulated light-up time is equal to or greater than baseLine_{—}01 and less than baseLine_{—}02. After S814 and S815, the processing is advanced to S816.

The processing of S816 is the same as the processing of S213 shown in FIG. 4.

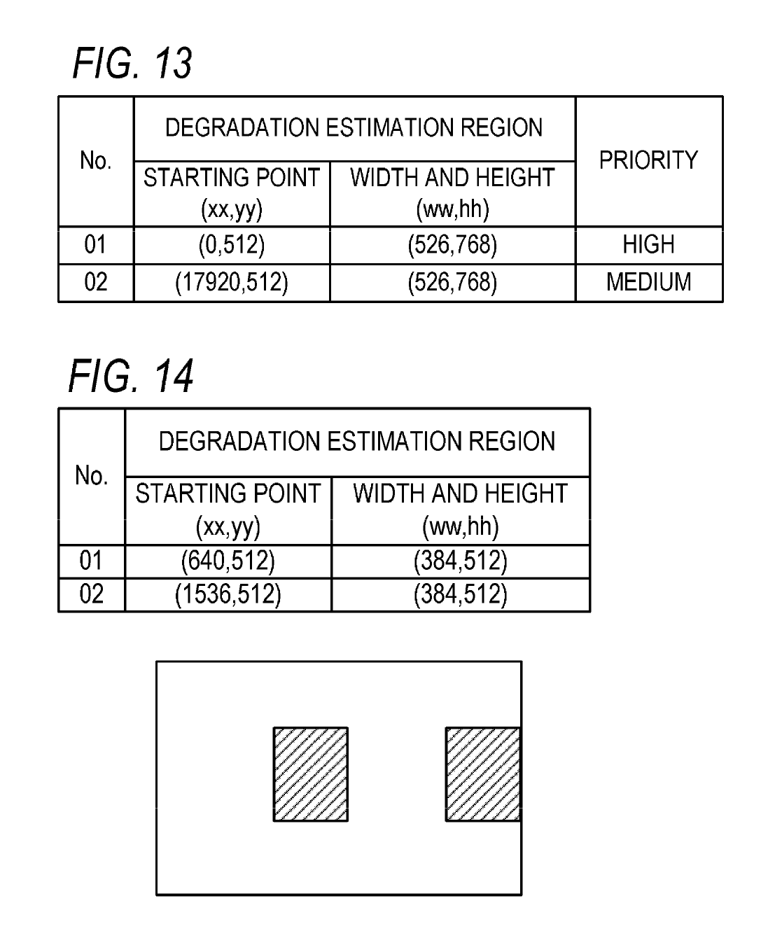

FIG. 13 illustrates an example of degradation estimation region information according to the present embodiment. In the present embodiment, a priority is associated with each region, by contrast with the degradation estimation region information (FIG. 5C) of Embodiment 1. In the example shown in FIG. 13, the degradation estimation region information represents the region with (xx, yy)=(0, 512), (ww, hh)=(526, 768), and “HIGH” priority and the region with (xx, yy)=(17920, 512), (ww, hh)=(526, 768), and “MEDIUM” priority.

Further, the present embodiment is configured such that the prioritization is performed in the case where a block that is present within one time range, from among a plurality of time ranges determined by a plurality of reference times, is a block for which the accumulated light-up time is the time within this time range, but such configuration is not limiting. For example, a configuration may be used in which the prioritization is performed by comparing the average value of accumulated light-up times of blocks for which the accumulated light-up time is equal to or longer than the minimum value of reference times with a plurality of reference times. Further, in the present embodiment, an example is described in which the number of reference times is equal to the number of time ranges, but such feature is not limiting. For example, where the reference times are T0, T1 (>T0), T2 (>T1), the degradation estimation region may be detected with respect to two time ranges, namely, a range of equal to or greater than T0 and less than T2 and a range of equal to or greater than T2. The degradation estimation region may be also detected with respect to two time ranges, namely, a range of equal to or greater than T0 and less than T1 and a range of equal to or greater than T2. Furthermore, the degradation estimation region may be also detected with respect to four time ranges, namely a range of less than T0, a range of equal to or greater than T0 and less than T1, a range of equal to or greater than T1 and less than T2, and a range of equal to or greater than T2.

The pattern image generating unit 300 uses the degradation estimation region information acquired from the degradation estimation region detection unit 200 to generate pattern image data for each time range such that the pattern component image is displayed in the block detected as a degradation estimation region corresponding to the time range. In the present embodiment, the pattern image data is generated for each priority so that the pattern component image is displayed in the block detected as a degradation estimation region corresponding to the priority. Where the degradation estimation region information is the information shown in FIG. 13, two pattern image data are generated. More specifically, pattern image data is generated such that the pattern component image is displayed in the region with (xx, yy)=(0, 512) and (ww, hh)=(526, 768), and pattern image data is generated such that the pattern component image is displayed in the region with (xx, yy)=(17920, 512) and (ww, hh)=(526, 768).

The display output unit 22 then successively outputs the pattern image data, starting from the data corresponding to a time range determined by a longer reference time (that is, starting from the pattern image data that has been generated so that the pattern component image is displayed in a degradation estimation region associated with a higher priority).

Therefore, during the visual inspection, the pattern images generated in the pattern image generating unit 300 are displayed successively starting from the pattern image in which the pattern component image is disposed in a degradation estimation region with a high priority. A plurality of pattern images generated in the pattern image generating unit 300 may be also successively displayed after the pattern image (FIG. 22) for visual inspection that is defined by the guidelines has been displayed. The pattern image shown in FIG. 22 may be also displayed after a plurality of pattern images generated in the pattern image generating unit 300 have been successively displayed.

As mentioned hereinabove, in the present embodiment, a degradation estimation region is detected in each time range determined by a plurality of reference times. The pattern image data is then generated such that for each time range the pattern component image is displayed in a block detected as a degradation estimation region corresponding to this time range. As a result, a plurality of pattern image data can be generated according to the degree of degradation, the pattern images can be viewed separately for each degree of degradation, and the degradation state of the image display apparatus can be examined more accurately.

Further, in the present embodiment, the pattern image data is successively outputted (displayed) starting from the data corresponding to a time range determined by a longer reference time (that is, starting from the pattern image data that has been generated so that the pattern component image is displayed in a degradation estimation region associated with a higher priority). As a result, the image for which the pattern component image is displayed in a region with a higher degree of degradation can be viewed preferentially, and the degradation state of the image display apparatus can be examined with good efficiency.

Further, in the present embodiment, visual inspection is presumed, but the pattern images created in the present embodiment may be also used for measurement inspection. When the measurement inspection is performed, the pattern image (FIG. 22) for visual inspection defined by the guidelines is not displayed, and a plurality of pattern images generated in the pattern image generating unit 300 are successively displayed. More specifically, the pattern image data is successively displayed starting from the data corresponding to a time range determined by a longer reference time (that is, starting from the pattern image data that has been generated so that the pattern component image is displayed in a degradation estimation region associated with a higher priority). The brightness of the pattern images is then measured by using a brightness meter provided in the monitor 10 or connected to the monitor 10 or PC 20, and the inspection of the degradation estimation region is performed.

### Embodiment 4

The image generating apparatus, image display apparatus, image generating method, and image display method according to Embodiment 4 of the present invention are described below. Functions different from those of Embodiment 1 are described hereinbelow in detail, and the explanation of functions same as those of Embodiment 1 is omitted.

In the present embodiment, the processing performed by the degradation estimation region detection unit 200 is different from that of Embodiment 1.

The degradation estimation region detection unit 200 takes the average time of accumulated light-up times of the blocks as a reference time to be used for detecting the degradation estimation region. Other features of the processing are the same as in Embodiment 1 and the explanation thereof is therefore omitted.

As mentioned hereinabove, in the present embodiment, the average time of accumulated light-up times of the blocks is taken as a reference time. Therefore, the reference time is changed dynamically according to display quality of the existing image display apparatus, and a block for which the probability of display quality degradation is higher than for other blocks can be taken as a degradation estimation region. As a result, the degradation state of the image display apparatus can be inspected with higher accuracy.

Further, in the present embodiment, visual inspection is presumed, but the pattern image created in the present embodiment may be also used for measurement inspection. When the measurement inspection is performed, the pattern image (FIG. 22) for visual inspection defined by the guidelines is not displayed, and a pattern image generated in the pattern image generating unit 300 is displayed. The brightness of the pattern image is then measured by using a brightness meter provided in the monitor 10 or connected to the monitor 10 or PC 20, and the inspection of the degradation estimation region is performed.

### Embodiment 5

The image generating apparatus, image display apparatus, image generating method, and image display method according to Embodiment 5 of the present invention are described below. Functions different from those of Embodiment 2 are described hereinbelow in detail, and the explanation of functions same as those of Embodiment 2 is omitted.

In the present embodiment, the processing performed by the pattern image generating unit 300 is different from that of Embodiment 2.

In Embodiment 2, the pattern image generating unit 300 generates a plurality of pattern image data in which pattern component images differ depending on the position of the degradation estimation region in the left-right direction of the screen (horizontal direction of the screen). In the present embodiment, the pattern image generating unit 300 generates a plurality of pattern image data in which the pattern component image does not depend on the position of the degradation estimation region.

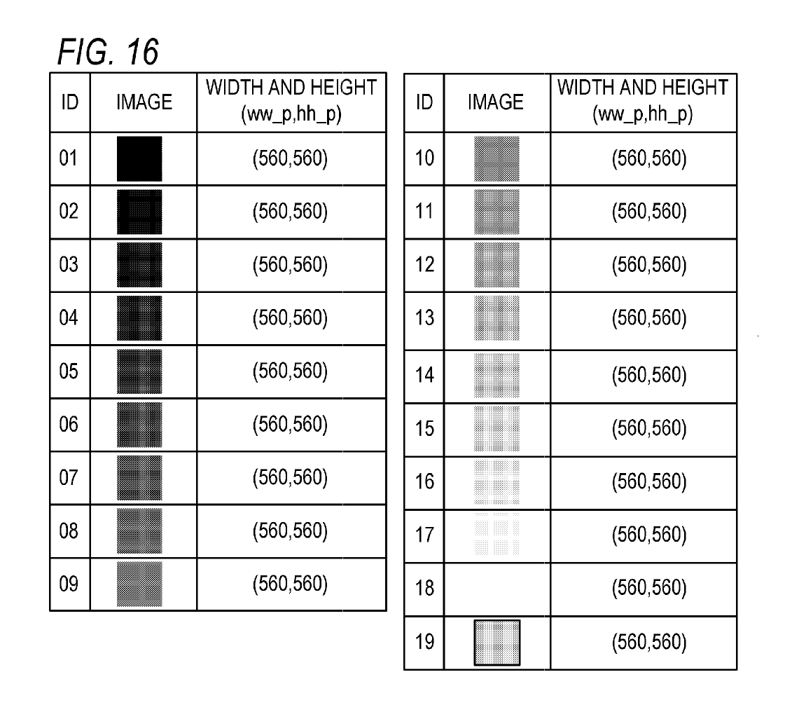

More specifically, in the present embodiment, data on a plurality of pattern component images of different types, such as shown in FIG. 16, is expanded in the RAM in the PC 20. The data on the pattern component images is managed by individually identifiable ID numbers. More specifically, numbers such as ID=01, 02, 03, . . . , 19 are associated with respective pattern component images. The pattern component image with ID=01 that is shown in FIG. 16 is an image with (R, G, B)=(0, 0, 0), and the images with ID=02 to ID=18 are obtained by varying the R value, G value, and B value of the pattern component image with ID=01 by a fixed amount. For example, the pattern component image with ID=02 is an image with (R, G, B)=(15, 15, 15) and the pattern component image with ID=03 is an image with (R, G, B)=(30, 30, 30). The pattern component image with ID=17 is an image with (R, G, B)=(240, 240, 240), and the pattern component image with ID=18 is an image with (R, G, B)=(255, 255, 255). Further, the pattern component image with ID=19 is a contoured image (image including a frame).

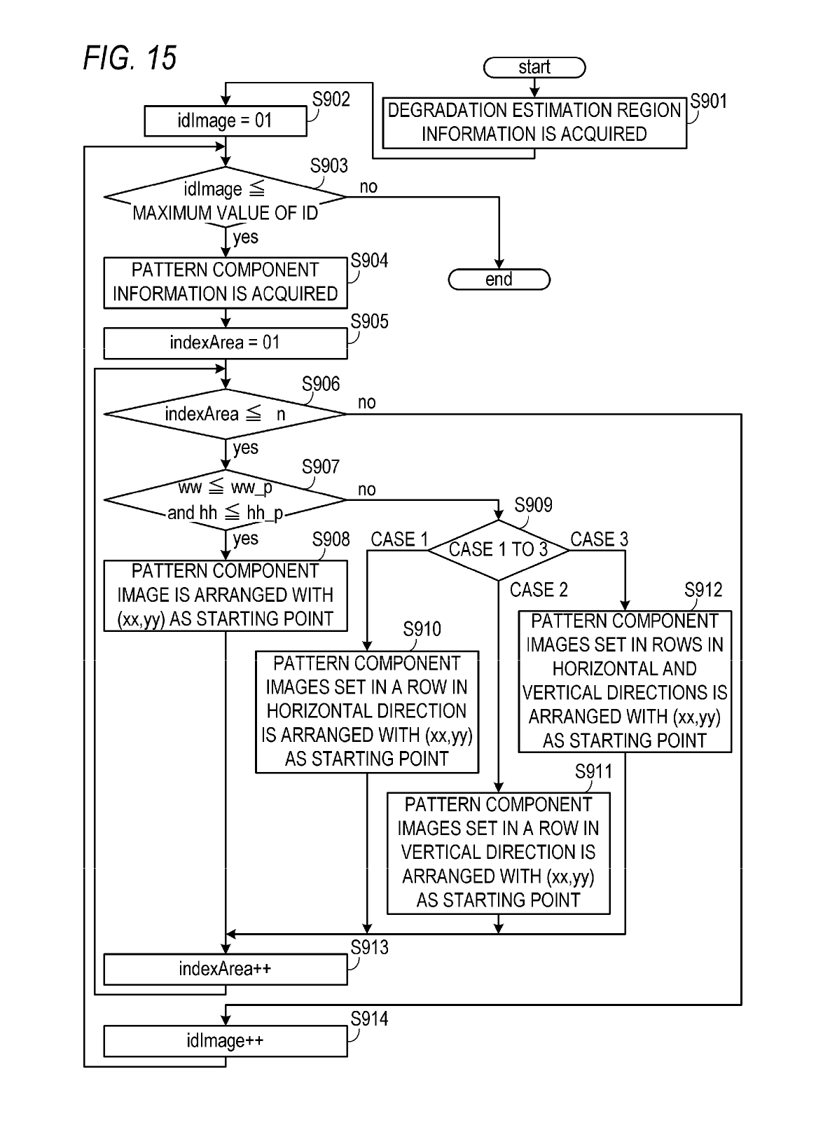

The details of the processing performed by the pattern image generating unit 300 will be described below with reference to the processing flowchart shown in FIG. 15.

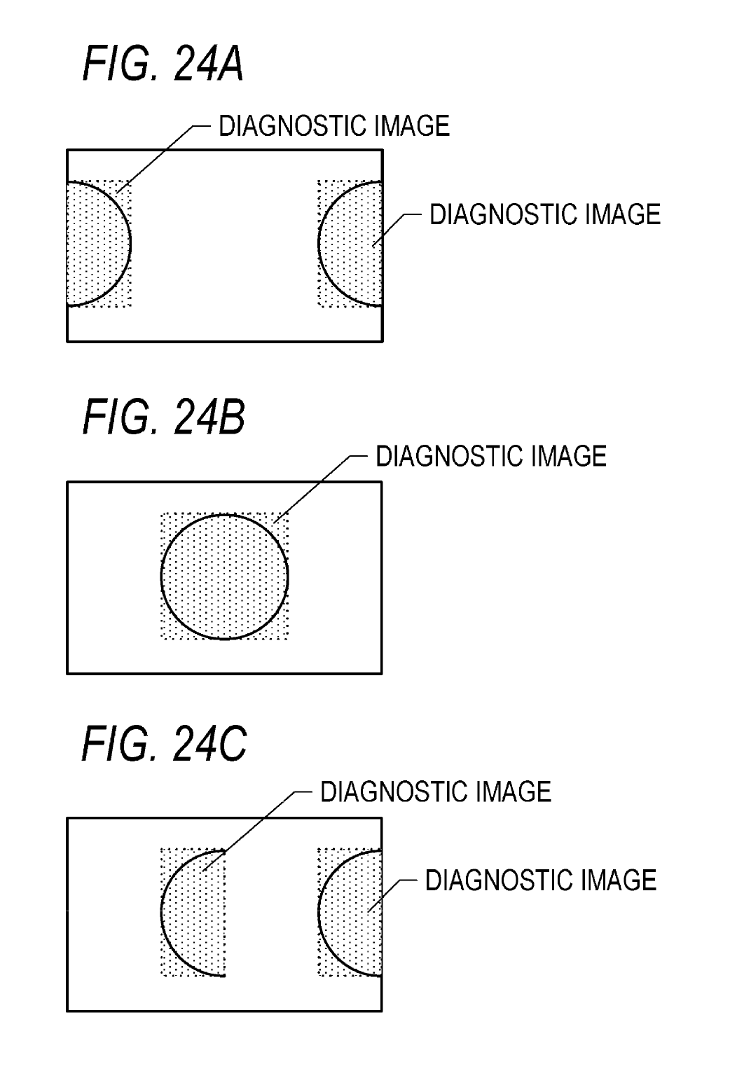

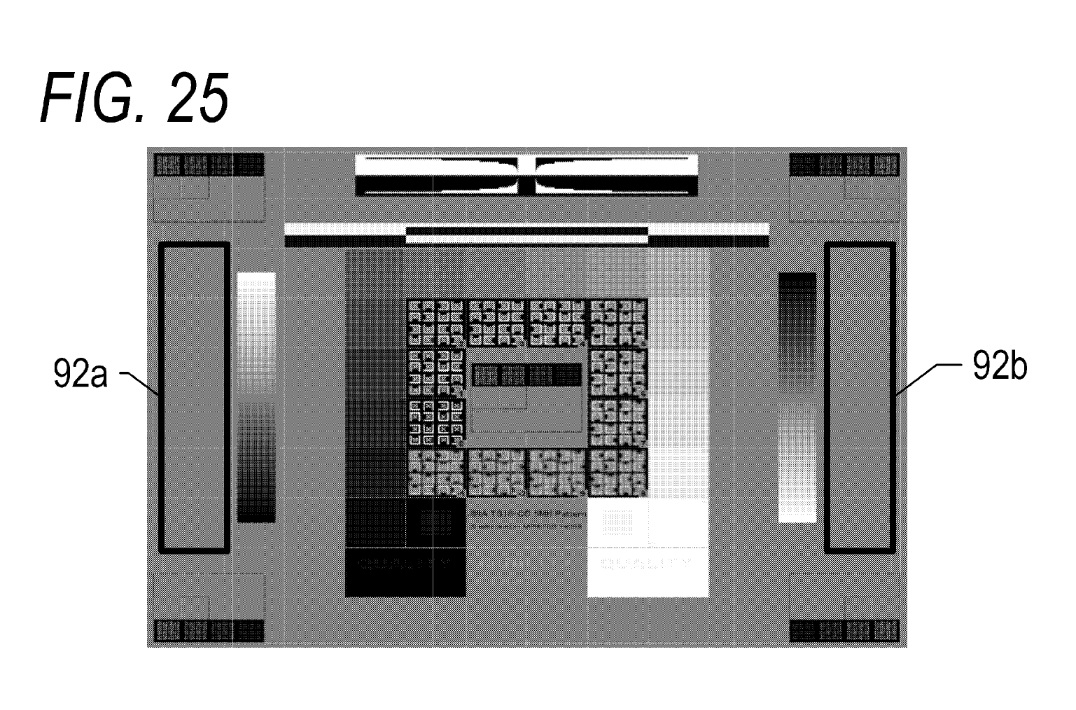

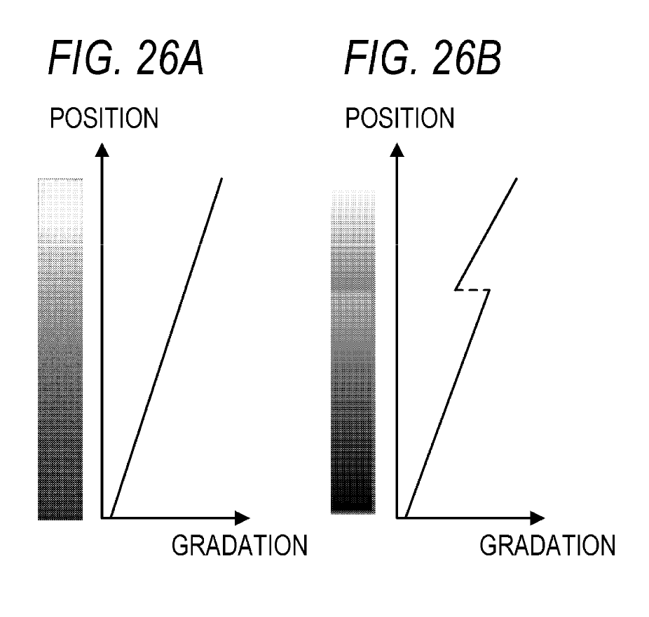

In S901, the pattern image generating unit 300 acquires degradation estimation region information from the degradation estimation region detection unit 200. An example of the degradation estimation region information is shown in FIG. 14. The rectangular hatched sections shown in FIG. 14 represent the degradation estimation regions of the monitor. The results of detection performed in the degradation estimation region detection unit 200 indicate that degradation estimation region on two locations, such as shown in FIG. 14, is detected. In this case, as shown in FIG. 24C, it is assumed that the monitor is degraded by displaying diagnostic images in the center and at the right end of the screen. In the present embodiment, it is assumed that the information representing the two regions is acquired as the degradation estimation region information. More specifically, it is assumed that the information representing a region with (xx, yy)=(640, 512) and (ww, hh)=(384, 512) and a region with (xx, yy)=(1536, 512) and (ww, hh)=(384, 512) is acquired.

The processing of S902 to S906 is the same as the processing of S702 to S706 shown in FIG. 9, and therefore the explanation thereof is herein omitted. Further, the processing of S907 to S914 is the same as the processing of S710 to S717 shown in FIG. 9, and therefore the explanation thereof is herein omitted. In the present embodiment, the processing of S903 to S914 is repeatedly performed till the idImage corresponds to a maximum value of 18 of image data ID.

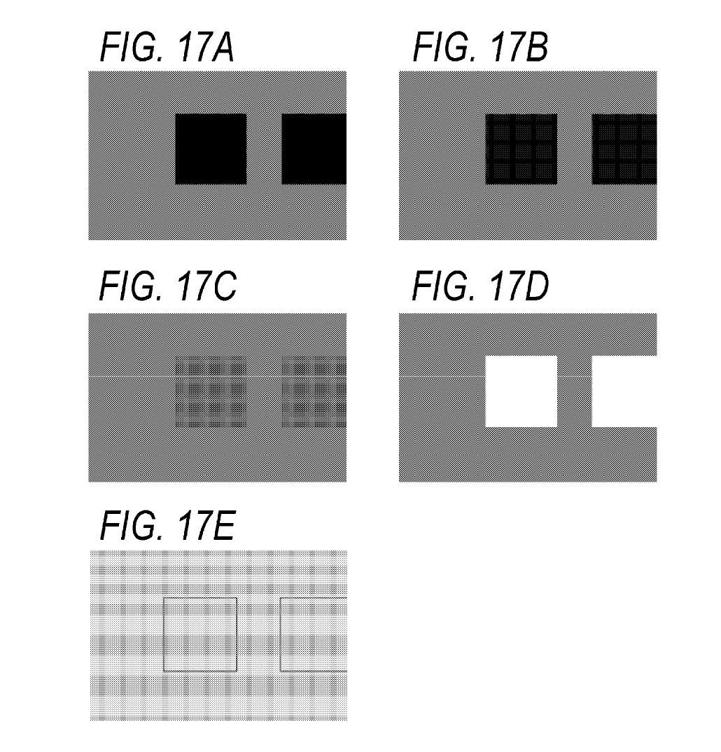

During the visual inspection, a plurality of pattern images (FIGS. 17A to 17E) generated in the pattern image generating unit 300 are successively displayed after the pattern image for visual inspection (FIG. 22) defined by the guidelines has been displayed. Here, only an example with five pattern images is shown in FIGS. 17A to 17E, but in the present embodiment, 19 pattern images are successively displayed. Alternatively, the pattern images (FIGS. 17A to 17E) generated by the pattern image generating unit 300 are successively displayed instead of the pattern image for visual inspection (FIG. 22) defined by the guidelines. The pattern image shown in FIG. 22 may be also displayed after the pattern images shown in FIGS. 17A to 17E have been displayed. Further, the display switching of test pattern images may be performed by the user's actions.

As shown in FIG. 17E, in the case of pattern component images contoured as the pattern component image with ID=19 that is shown in FIG. 16, the color of pattern image may be the same as that of the background region. In the pattern images shown in FIGS. 17A to 17E, the pattern component images are disposed in the degradation estimation regions, but the pattern component image may be also disposed in the degradation estimation regions and the regions outside the degradation estimation regions. The pattern images shown in FIGS. 17A to 17E are obtained, for example, by partial modification of the pattern image for measurement inspection (JIRA TG18-LN8) defined by the guidelines.

As described hereinabove, according to the present embodiment, a plurality of image data with different types of pattern component images is generated such that the RGB values of pattern component images vary by fixed amount. As a result, when a plurality of pattern images of different types is prepared, those images can be displayed for inspection in degradation estimation regions. As a result, the degradation state of the image display apparatus can be inspected with higher accuracy.

Further, in the present embodiment, visual inspection is presumed, but the pattern images created in the present embodiment may be also used for measurement inspection. When the measurement inspection is performed, the pattern image (FIG. 22) for visual inspection defined by the guidelines is not displayed, and a plurality of pattern images (FIG. 17A to 17E) generated in the pattern image generating unit 300 is successively displayed. The brightness of the pattern images is then measured by using a brightness meter provided in the monitor 10 or connected to the monitor 10 or PC 20, and the inspection of the degradation estimation region is performed.

### Embodiment 6

The image generating apparatus, image display apparatus, image generating method, and image display method according to Embodiment 6 of the present invention are described below. Functions different from those of Embodiment 1 are described hereinbelow in detail, and the explanation of functions same as those of Embodiment 1 is omitted.

In the present embodiment, the processing performed by the pattern image generating unit 300 is different from that of Embodiment 1.

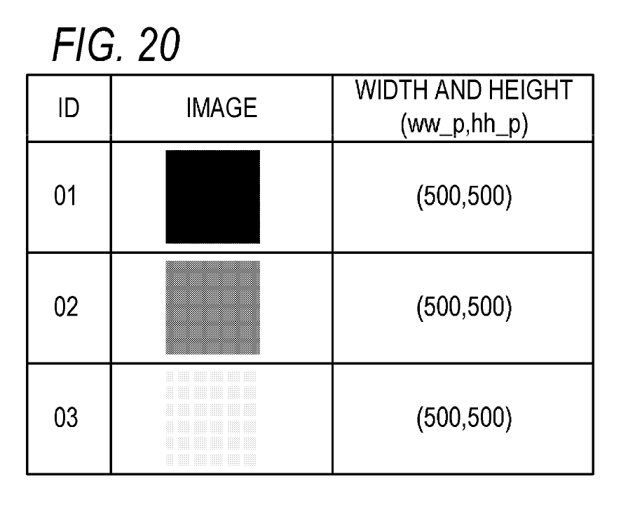

In Embodiment 1, the pattern image generating unit 300 generates the pattern image such that when the size of the degradation estimation region is larger than the size of the pattern component image, identical pattern component images are displayed in a row in the horizontal or vertical direction. By contrast, in the present embodiment, the pattern image generating unit 300 generates a pattern image such that when the size of the degradation estimation region is larger than the size of the pattern component images, a plurality of pattern component images of different types is displayed in a row. In the present embodiment, it is assumed that data on a plurality of pattern component images of different types, such as shown in FIG. 20, is expanded in the RAM in the PC 20. The data on the pattern component images is associated with respective numbers, namely, ID=01, 02, 03.

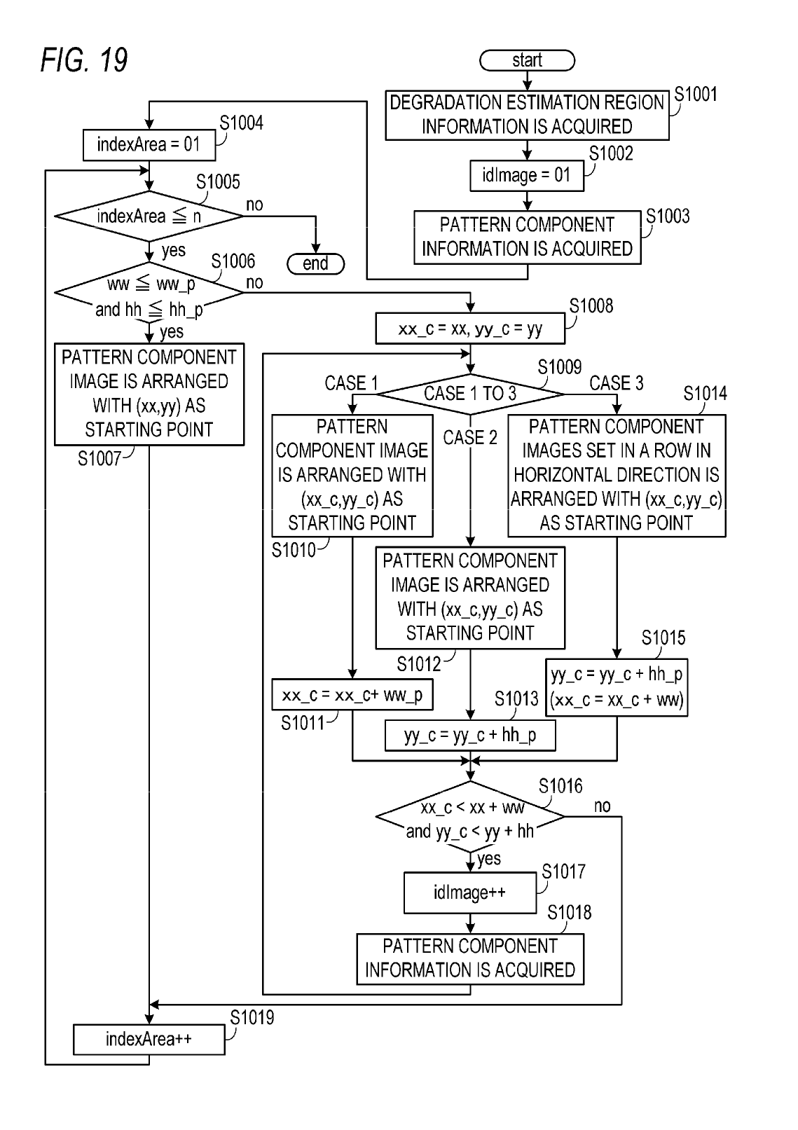

The details of the processing performed by the pattern image generating unit 300 will be described below with reference to the processing flowchart shown in FIG. 19.

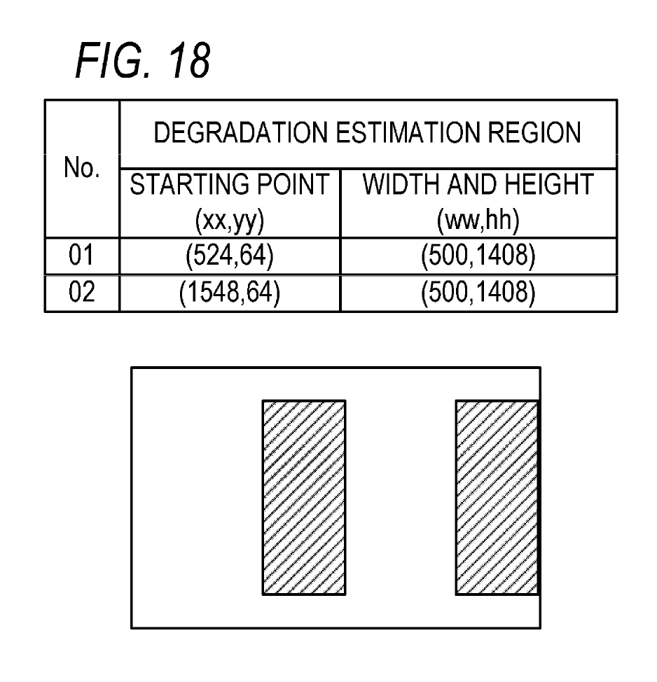

In S1001, the pattern image generating unit 300 acquires degradation estimation region information from the degradation estimation region detection unit 200. An example of the degradation estimation region information is shown in FIG. 18. The rectangular hatched sections shown in FIG. 18 represent the degradation estimation regions of the monitor. The results of detection performed in the degradation estimation region detection unit 200 indicate that degradation estimation region on two locations, such as shown in FIG. 18, is detected. In the present embodiment, it is assumed that the information representing the two regions is acquired as the degradation estimation region information. More specifically, it is assumed that the information representing a region with (xx, yy)=(524, 64) and (ww, hh)=(500, 1408) and a region with (xx, yy)=(1548, 64) and (ww, hh)=(500, 1408) is acquired.

In S1002, the pattern image generating unit 300 initializes to 01 the variable idImage that specifies the ID of image data that will be referred to from among the data on the pattern component images expanded in the RAM. In this case, the idImage is a variable indicating the ID that identifies the pattern component image stored in the PC 20.

The processing of S1003 to S1005 is the same as the processing of S302 to S304 shown in FIG. 6, and therefore the explanation thereof is herein omitted.

The processing of S1006 to S1007 is the same as the processing of S308 to S309 shown in FIG. 6, and therefore the explanation thereof is herein omitted.

In S1008, the pattern image generating unit 300 sets a starting point (xx_c, yy_c) for arranging a pattern component image. More specifically, xx is substituted in the horizontal coordinate value xx_c of the starting point for arranging a pattern component image, and yy is substituted in the vertical coordinate value yy_c of the starting point for arranging a pattern component image.

The processing of S1009 is the same as the processing of S310 shown in FIG. 6, and therefore the explanation thereof is herein omitted.

In S1010, the pattern image generating unit 300 generates (updates) a pattern image such that the selected pattern component image is displayed with (xx_c, yy_c) as a starting point.

In S1011, the pattern image generating unit 300 adds a width ww_p to xx_c and subtracts ww_p from ww.

In S1012, the pattern image generating unit 300 generates a pattern image such that the selected pattern component image is displayed with (xx_c, yy_c) as a starting point.

In S1013, the pattern image generating unit 300 adds a height hh_p to yy_c and subtracts hh_p from hh.

In S1014, the pattern image generating unit 300 generates a pattern image such that the number of selected pattern component images displayed in the horizontal direction is ww/ww_p, with (xx_c, yy_c) as a starting point.

In S1015, the pattern image generating unit 300 adds the height hh_p to yy_c and subtracts hh_p from hh. However, when the value obtained by adding the height hh_p to yy_c is larger than the value obtained by adding the initial value of the height hh to the vertical coordinate value yy, the pattern image generating unit 300 adds the width ww to xx_c.

In S1016, the pattern image generating unit 300 determines whether or not the starting point (xx_c, yy_c) for arranging the pattern component image is within the range of degradation estimation regions.

When xx_c is equal to or less than the value obtained by adding the initial value of the width ww to the horizontal coordinate value xx of the starting point of the degradation estimation region, and yy_c is equal to or less than the value obtained by adding the initial value of the height hh to the vertical coordinate value yy of the starting point of the degradation estimation region (S1016: yes), the processing is advanced to S1017. Otherwise (S1016: no), the processing is advanced to S1019.

In S1017, the pattern image generating unit 300 adds 1 to idImagen, and in S1018, pattern component information is acquired and the processing is returned to S1009. The processing of S1009 to S1018 is repeatedly performed till the starting point (xx_c, yy_c) falls outside the range of degradation estimation regions. The “no” determination is then made in S1016, and the processing is advanced to S1019.

The processing of S1019 is the same as the processing of S314 shown in FIG. 6, and therefore the explanation thereof is herein omitted.

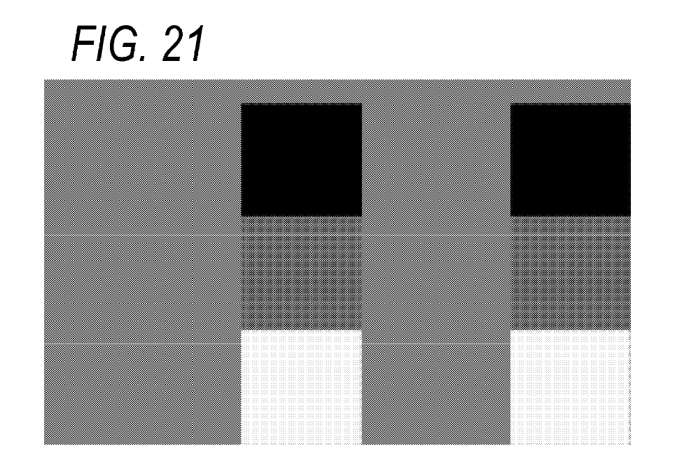

During the visual inspection, the pattern image (FIG. 21) generated in the pattern image generating unit 300 is displayed after the pattern image for visual inspection (FIG. 22) defined by the guidelines has been displayed. Alternatively, the pattern image (FIG. 21) generated by the pattern image generating unit 300 is displayed instead of the pattern image for visual inspection (FIG. 22) defined by the guidelines. The pattern image shown in FIG. 22 may be also displayed after the pattern image shown in FIG. 21 has been displayed. The pattern image shown in FIG. 21 is obtained by partially changing, for example, the pattern image for visual inspection (JIRA TG18-LN8) defined by the guidelines.

As described hereinabove, according to the present embodiment, pattern image data is generated such that a plurality of pattern component images is displayed in the degradation estimation regions. As a result, the degradation state of the image display apparatus can be detected with higher accuracy.

Further, in the present embodiment, visual inspection is presumed, but the pattern image created in the present embodiment may be also used for measurement inspection. When the measurement inspection is performed, the pattern image (FIG. 22) for visual inspection defined by the guidelines is not displayed, and pattern image (FIG. 21) generated in the pattern image generating unit 300 is displayed. The brightness of the pattern image is then measured by using a brightness meter provided in the monitor 10 or connected to the monitor 10 or PC 20, and the inspection of the degradation estimation region is performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-277396, filed on Dec. 19, 2011, and Japanese Patent Application No. 2012-201920, filed on Sep. 13, 2012, which are hereby incorporated by reference herein in their entirety.

What is claimed is:

1. An image generating apparatus that generates pattern image data including a pattern component image for inspecting display quality of an image display apparatus in which an emission brightness of a backlight can be controlled for each block obtained by dividing a screen,
the image generating apparatus comprising:
a detecting unit that detects a block in which display quality is estimated to be degraded, from among the blocks of the image display apparatus, as a degradation estimation region; and
a generating unit that generates pattern image data such that the pattern component image is displayed in a block detected as the degradation estimation region by the detecting units when an image based on the pattern image data is displayed by the image display apparatus.

2. The image generating apparatus according to claim 1, wherein
the generating unit generates a plurality of pattern image data with different types of pattern component images.

3. The image generating apparatus according to claim 1, wherein
the detecting unit
compares for each block an accumulated light-up time in which the backlight is lit up with an emission brightness equal to or greater than a predetermined value with a reference time; and
detects a block, for which the accumulated light-up time is equal to or longer than the reference time, as the degradation estimation region.

4. The image generating apparatus according to claim 3, wherein
the reference time includes a plurality of reference times, each having a different length, and
the detecting unit
compares for each block an accumulated light-up time with the plurality of reference times, and
detects, for each time range among at least some time ranges from among a plurality of time ranges determined by the plurality of reference times, a block for which an accumulated light-up time is a time within the time range as the degradation estimation region; and
the generating unit generates pattern image data for each time range, such that the pattern component image is displayed in a block detected as a degradation estimation region corresponding to the time range.

5. The image generating apparatus according to claim 4, further comprising
an outputting unit that outputs pattern image data generated by the generating unit to the image display apparatus, wherein
the outputting unit outputs pattern image data successively starting from pattern image data corresponding to a time range determined by a longer reference time.

6. The image generating apparatus according to claim 3, wherein
the reference time is set by a user.

7. The image generating apparatus according to claim 3, wherein
the reference time is an average time of accumulated light-up times of the blocks.

8. An image display apparatus in which an emission brightness of a backlight can be controlled for each block obtained by dividing a screen,
the image display apparatus comprising:
a detecting unit that detects a block in which display quality is estimated to be degraded, from among the blocks, as a degradation estimation region; and
a display control unit that displays a pattern component image for inspecting display quality in block detected as the degradation estimation region by the detecting unit.

9. An image generating method for generating pattern image data including a pattern component image for inspecting display quality of an image display apparatus in which an emission brightness of a backlight can be controlled for each block obtained by dividing a screen,
the image generating method comprising:
a detection step in which a computer detects a block in which display quality is estimated to be degraded, from among the blocks of the image display apparatus, as a degradation estimation region; and
a generation step in which the computer generates pattern image data such that the pattern component image is displayed in a block detected as the degradation estimation region in the detection step when an image based on the pattern image data is displayed by the image display apparatus.

10. The image generating method according to claim 9, wherein
in the generation step, a plurality of pattern image data with different types of pattern component images are generated.

11. The image generating method according to claim 9, wherein
in the detection step,
an accumulated light-up time in which the backlight is lit up with an emission brightness equal to or greater than a predetermined value is compared with a reference time for each block; and
a block for which the accumulated light-up time is equal to or longer than the reference time is detected as the degradation estimation region.

12. The image generating method according to claim 11, wherein
the reference time includes a plurality of reference times, each having a different length, and
in the detection step,
an accumulated light-up time is compared with the plurality of reference times for each block, and
for each time range among at least some time ranges from among a plurality of time ranges determined by the plurality of reference times, a block for which an accumulated light-up time is a time within the time range is detected as the degradation estimation region; and
in the generation step, pattern image data is generated for each time range, such that the pattern component image is displayed in a block detected as a degradation estimation region corresponding to the time range.

13. The image generating method according to claim 12, further comprising
an output step of outputting pattern image data generated in the generation step to the image display apparatus, wherein
in the output step, the pattern image data is successively outputted starting from pattern image data corresponding to a time range determined by a longer reference time.

14. The image generating method according to claim 11, wherein
the reference time is set by a user.

15. The image generating method according to claim 11, wherein
the reference time is an average time of accumulated light-up times of the blocks.

16. An image display method for image display in an image display apparatus in which an emission brightness of a backlight can be controlled for each block obtained by dividing a screen,
the method comprising:
a detection step in which a computer detects a block in which display quality is estimated to be degraded, from among the blocks, as a degradation estimation region; and
a display control step in which the computer displays a pattern component image for inspecting display quality in block detected as the degradation estimation region in the detection step.
